(19) United States
(12) Patent Application Publication
(10) Pub. No.: US 2025/0218660 A1
(43) Pub. Date: Jul. 3, 2025

(54) MULTILAYER ELECTRONIC COMPONENT

(71) Applicant: SAMSUNG ELECTRO-MECHANICS CO., LTD., Suwon-si (KR)

(72) Inventors: Ho In JUN, Suwon-si (KR); Chul Seung LEE, Suwon-si (KR); Kyo Sik KIM, Suwon-si (KR); Seong Min OH, Suwon-si (KR)

(73) Assignee: SAMSUNG ELECTRO-MECHANICS CO., LTD., Suwon-si (KR)

(21) Appl. No.: 18/983,589

(22) Filed: Dec. 17, 2024

(30) Foreign Application Priority Data
Dec. 28, 2023 (KR) 10-2023-0195449
Mar. 6, 2024 (KR) 10-2024-0032177

(51) Int. Cl. H01G 4/005; H01G 4/12; H01G 4/232; H01G 4/30

(52) U.S. Cl. CPC H01G 4/005; H01G 4/12; H01G 4/232; H01G 4/30

(57) ABSTRACT

A multilayer electronic component includes a body including a dielectric layer and first and second internal electrodes alternately disposed with the dielectric layer and including first to fourth portions, first and second external electrodes disposed on the first and second portions, respectively and connected to the first internal electrodes, third and fourth external electrodes disposed on the third and fourth portions, respectively and connected to the second internal electrodes, and a connection electrode disposed in at least one of the first to fourth portions, penetrating the dielectric layer, connecting two first internal electrodes or two internal electrodes adjacent to each other in the first direction. The connection electrode has a plurality of via electrodes laminated in the first direction, and via electrodes adjacent to each other in the first direction among the plurality of via electrodes, are shifted from each other in a direction perpendicular to the first direction.

### CROSS-REFERENCE TO RELATED APPLICATION(S)

This application claims benefit of priority to Korean Patent Application No. 10-2024-0032177 filed on Mar. 6, 2024 and Korean Patent Application No. 10-2023-0195449 filed on Dec. 28, 2023 in the Korean Intellectual Property Office, the disclosures of which are incorporated herein by reference in their entirety.

### BACKGROUND

### 1. Field

The present disclosure relates to a multilayer electronic component.

### 2. Description of Related Art

A multilayer ceramic component (MLCC), a multilayer electronic component, may be a chip condenser mounted on the printed circuit boards of various electronic products including image display devices such as a liquid crystal display (LCD) and a plasma display panel (PDP), a computer, a smartphone, a mobile phone, or the like, and charging or discharging electricity therein or therefrom. Such a multilayer ceramic capacitor may be used as a component of various electronic devices, since a multilayer ceramic capacitor may have a small size and high capacitance and may be easily mounted.

An MLCC may include generally a body including a plurality of internal electrodes alternately disposed with dielectric layers, and an external electrode disposed externally of the body and connected to the plurality of internal electrodes.

During the sintering process for manufacturing MLCC, the internal electrode may shrink or cracks may occur in the body, such that connection between the internal electrode and the external electrode may be broken, which may cause reduction of capacitance of an MLCC.

### SUMMARY

An embodiment of the present disclosure is to provide a multilayer electronic component having excellent mechanical strength and electrical properties.

According to an embodiment of the present disclosure, a multilayer electronic component includes a body including a dielectric layer and first and second internal electrodes alternately disposed with the dielectric layer, and including first and second surfaces opposing each other in a first direction, a third surface and a fourth surface connected to the first and second surfaces and opposing each other in a second direction, and fifth and sixth surfaces connected to the first to fourth surfaces and opposing each other in a third direction, the body including first to fourth portions; first and second external electrodes disposed on the first and second portions, respectively, and connected to the first internal electrodes; third and fourth external electrodes disposed on the third and fourth portions, respectively, and connected to the second internal electrodes; and a connection electrode disposed in at least one of the first to fourth portions, penetrating the dielectric layer, connecting two first internal electrodes adjacent to each other in the first direction, or connecting two second internal electrodes adjacent to each other in the first direction. the first portion and the third portion are connected to each other in the second direction, the first portion and the fourth portion are connected to each other in the third direction, the second portion and the third portion are connected to each other in the third direction, and the second portion and the fourth portion are connected to each other in the second direction. The first portion includes a corner at which the third and fifth surfaces meet each other, the second portion includes a corner at which the fourth and sixth surfaces meet each other, the third portion includes a corner at which the fourth and fifth surfaces meet each other, and the fourth portion includes a corner at which the third and sixth surfaces meet each other. The connection electrode has a plurality of via electrodes laminated in the first direction, and via electrodes adjacent to each other in the first direction among the plurality of via electrodes, are shifted from each other in a direction perpendicular to the first direction.

According to an embodiment of the present disclosure, a multilayer electronic component includes a body including first and second surfaces opposing each other in a first direction, a third surface and a fourth surface connected to the first and second surfaces and opposing each other in a second direction, and fifth and sixth surfaces connected to the first to fourth surfaces and opposing each other in a third direction, the body including first to fourth portions, the body including a first internal electrode layer including a first dielectric layer, a first internal electrode disposed on the first dielectric layer, and third and fourth auxiliary electrodes disposed on the first dielectric layer, spaced apart from the first internal electrode and disposed on the third and fourth portion, respectively, the body including a second internal electrode layer including a second dielectric layer, a second internal electrode disposed on the second dielectric layer, and first and second auxiliary electrodes disposed on the second dielectric layer, spaced apart from the second internal electrode, and disposed in the first and second portions, respectively, in the body, the first and second internal electrode layers are alternately disposed in the first direction; first and second external electrodes disposed on the first and second portions, respectively, and connected to the first internal electrode; third and fourth external electrodes disposed on the third and fourth portions, respectively, and connected to the second internal electrode; a first via electrode disposed on the first portion, penetrating the first dielectric layer and connecting the first internal electrode to the first auxiliary electrode; and a second via electrode disposed on the first portion, penetrating the second dielectric layer and connecting the first internal electrode to the first auxiliary electrode. The first portion and the third portion are connected to each other in the second direction, the first portion and the fourth portion are connected to each other in the third direction, the second portion and the third portion are connected to each other in the third direction, and the second portion and the fourth portion are connected to each other in the second direction. The first portion includes a corner at which the third and fifth surfaces meet each other, the second portion includes a corner at which the fourth and sixth surfaces meet each other, the third portion includes a corner at which the fourth and fifth surfaces meet each other, and the fourth portion includes a corner at which the third and sixth surfaces meet each other. The first via electrode and the second via electrode are shifted from each other in a direction perpendicular to the first direction.

According to an embodiment of the present disclosure, a multilayer electronic component includes a body including a dielectric layer and first and second internal electrodes alternately disposed with the dielectric layer, and including first and second surfaces opposing each other in a first direction, a third surface and a fourth surface connected to the first and second surfaces and opposing each other in a second direction, and fifth and sixth surfaces connected to the first to fourth surfaces and opposing each other in a third direction; a first external electrode disposed at least on the third surface to connect to the first internal electrodes that extend to the third surface; a third external electrode disposed at least on the fourth surface to connect to the second internal electrodes that extend to the fourth surface; and a connection electrode disposed in a region where one of the second internal electrodes is spaced apart from the third surface to connect two first internal electrodes adjacent to each other in the first direction among the first internal electrodes. The connection electrode includes a first via electrode extending from one of the two first internal electrodes and a second via electrode extending from another of the two first internal electrodes.

According to an embodiment of the present disclosure, a multilayer electronic component includes a body including a dielectric layer and first and second internal electrodes alternately disposed with the dielectric layer, and including first and second surfaces opposing each other in a first direction, a third surface and a fourth surface connected to the first and second surfaces and opposing each other in a second direction, and fifth and sixth surfaces connected to the first to fourth surfaces and opposing each other in a third direction, the body including a capacitance formation portion in which the first and second internal electrodes are alternately disposed in the first direction with the dielectric layer interposed therebetween, and a cover portion disposed on both surfaces of the capacitance formation portion in the first direction; a first external electrode disposed at least on the first surface to connect to the first internal electrodes; a third external electrode disposed at least on the first surface to connect to the second internal electrodes; a connection electrode disposed in a region where one of the second internal electrodes is spaced apart from the third surface to connect two first internal electrodes adjacent to each other in the first direction among the first internal electrodes; and a contact structure penetrating the cover portion to connect the first internal electrode disposed in an outermost region with respect to the first direction to the first external electrode. The connection electrode includes a first via electrode extending directly from one of the two first internal electrodes and a second via electrode extending directly from another of the two first internal electrodes.

### BRIEF DESCRIPTION OF DRAWINGS

The and other aspects, features, and advantages of the present disclosure will be more clearly understood from the following detailed description, taken in combination with the accompanying drawings, in which:

FIG. 1 is a perspective diagram illustrating a multilayer electronic component according to a first embodiment of the present disclosure;

FIG. 2 is a cross-sectional diagram taken along line I1-I1′in FIG. 1;

FIG. 3 is a cross-sectional diagram taken along line II1-II1′ in FIG. 1;

FIG. 4A is a cross-sectional diagram taken along line III1-III1′ in FIG. 1;

FIG. 4B is a cross-sectional diagram taken along line IV1-IV1′in FIG. 1;

FIG. 5 is an enlarged diagram illustrating region A in FIG. 2;

FIG. 6 is a perspective diagram illustrating a multilayer electronic component according to a first modified example of a first embodiment of the present disclosure;

FIG. 7 is a cross-sectional diagram taken along line I2-I2′ in FIG. 6;

FIG. 8 is a cross-sectional diagram taken along line II2-II2′ in FIG. 6;

FIG. 9A is a cross-sectional diagram taken along line III2-III2′ in FIG. 7;

FIG. 9B is a cross-sectional diagram taken along line IV2-IV2′ in FIG. 7;

FIGS. 10A and 10B are cross-sectional diagrams illustrating a multilayer electronic component according to a second modified example of a first embodiment of the present disclosure, corresponding to FIGS. 9A and 9B;

FIGS. 11A and 11B are cross-sectional diagrams illustrating a multilayer electronic component according to a third modified example of a first embodiment of the present disclosure, corresponding to FIGS. 9A and 9B;

FIG. 12 is a perspective diagram illustrating a multilayer electronic component according to a fourth modified example of a first embodiment of the present disclosure;

FIG. 13 is a cross-sectional diagram taken along line I3-I3′ in FIG. 12;

FIG. 14 is a cross-sectional diagram taken along line II3-II3′ in FIG. 12;

FIG. 15A is a cross-sectional diagram taken along line III3-III3′ in FIG. 13;

FIG. 15B is a cross-sectional diagram taken along line IV3-IV3′ in FIG. 13;

FIG. 16 is a perspective diagram illustrating a multilayer electronic component according to a fifth modified example of a first embodiment of the present disclosure;

FIG. 17 is a cross-sectional diagram taken along line I4-I4′ in FIG. 16;

FIG. 18 is a cross-sectional diagram taken along line II4-II4′ in FIG. 16;

FIG. 19A is a cross-sectional diagram taken along line III4-III4′ in FIG. 17;

FIG. 19B is a cross-sectional diagram taken along line VI4-VI4′ in FIG. 17;

FIG. 20 is a perspective diagram illustrating a multilayer electronic component according to a sixth modified example of a first embodiment of the present disclosure;

FIG. 21 is a cross-sectional diagram taken along line I5-I5′ in FIG. 20;

FIG. 22 is a cross-sectional diagram taken along line II5-115′ in FIG. 20;

FIG. 23 is a perspective diagram illustrating a multilayer electronic component according to a second embodiment of the present disclosure;

FIG. 24 is an exploded perspective diagram illustrating a body of a multilayer electronic component according to a second embodiment of the present disclosure;

FIG. 25 is a cross-sectional diagram taken along line I6-I6′ in FIG. 23;

FIG. 26 is a cross-sectional diagram taken along line II6-II6′ in FIG. 23;

FIG. 27A is a cross-sectional diagram taken along line III6-III6′ in FIG. 25;

FIG. 27B is a cross-sectional diagram taken along line IV6-IV6′ in FIG. 25;

FIG. 28 is an enlarged diagram illustrating region B in FIG. 25;

FIGS. 29A and 29B are cross-sectional diagrams illustrating a multilayer electronic component according to a first modified example of a second embodiment of the present disclosure, corresponding to FIGS. 27A and 27B;

FIGS. 30A and 30B are cross-sectional diagrams illustrating a multilayer electronic component according to a second modified example of a second embodiment of the present disclosure, corresponding to FIGS. 27A and 27B;

FIG. 31 is a perspective diagram illustrating a multilayer electronic component according to a third modified example of a second embodiment of the present disclosure;

FIG. 32 is a cross-sectional diagram taken along line I7-I7′ in FIG. 31;

FIG. 33 is a cross-sectional diagram taken along line II7-II7′ in FIG. 31;

FIG. 34A is a cross-sectional diagram taken along line III7-III7′ in FIG. 32;

FIG. 34B is a cross-sectional diagram taken along line IV7-IV7′ in FIG. 32;

FIG. 35 is a perspective diagram illustrating a multilayer electronic component according to a fourth modified example of a second embodiment of the present disclosure;

FIG. 36 is a cross-sectional diagram taken along line I8-I8′ in FIG. 34;

FIG. 37 is a cross-sectional diagram taken along line II8-II8′ in FIG. 34;

FIG. 38 is a cross-sectional diagram illustrating a filling and printing process for manufacturing a multilayer electronic component according to a first or second embodiment of the present disclosure;

FIGS. 39 to 41 are cross-sectional diagrams illustrating a modified example of FIG. 38.

### DETAILED DESCRIPTION

Hereinafter, embodiments of the present disclosure will be described as below with reference to the accompanying drawings.

These embodiments are described in sufficient detail to enable those skilled in the art to practice the invention. It is to be understood that the various embodiments of the invention, although different, are not necessarily mutually exclusive. For example, structures, shapes, and sizes described as examples in embodiments in the present disclosure may be implemented in another embodiment without departing from the spirit and scope of the present disclosure. Further, modifications of positions or arrangements of elements in embodiments may be made without departing from the spirit and scope of the present disclosure. The following detailed description is, accordingly, not to be taken in a limiting sense, and the scope of the present disclosure are defined only by appended claims, appropriately interpreted, along with the full range of equivalents to which the claims are entitled.

In the drawings, same elements will be indicated by same reference numerals. Also, redundant descriptions and detailed descriptions of known functions and elements which may unnecessarily make the gist of the present disclosure obscure will be omitted. In the accompanying drawings, some elements may be exaggerated, omitted or briefly illustrated, and the sizes of the elements do not necessarily reflect the actual sizes of these elements. The terms, “include,” “comprise,” “is configured to,” or the like of the description are used to indicate the presence of features, numbers, steps, operations, elements, portions or combination thereof, and do not exclude the possibilities of combination or addition of one or more features, numbers, steps, operations, elements, portions or combination thereof.

In the drawings, the first direction may be defined as a thickness (T) direction, the second direction may be defined as a length (L) direction, and the third direction may be defined as a width (W) direction.

### (First Embodiment)

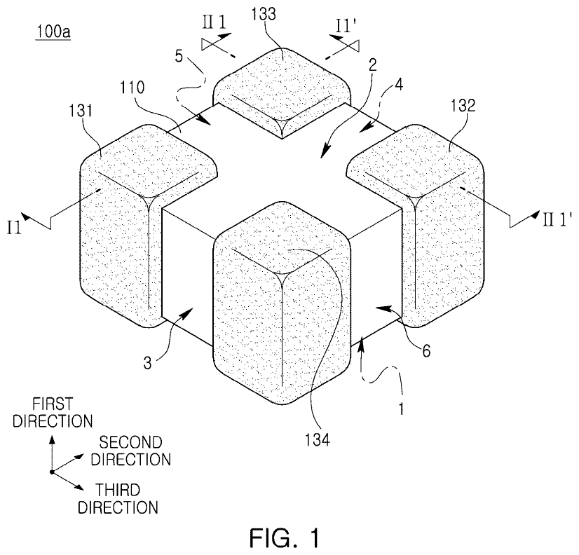

FIG. 1 is a perspective diagram illustrating a multilayer electronic component according to a first embodiment.

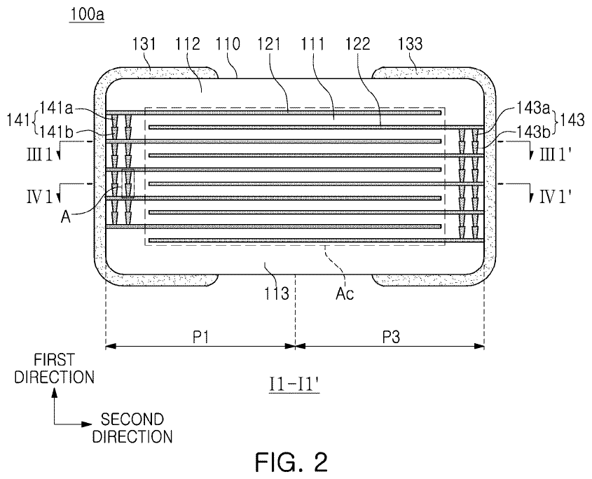

FIG. 2 is a cross-sectional diagram taken along line I1-I1′ in FIG. 1.

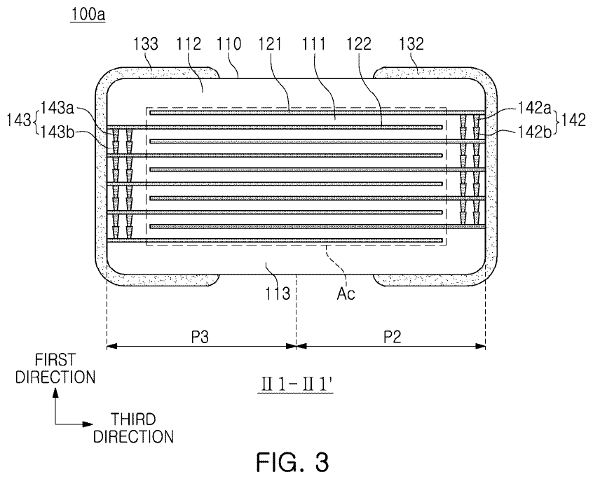

FIG. 3 is a cross-sectional diagram taken along line II1-II1′ in FIG. 1.

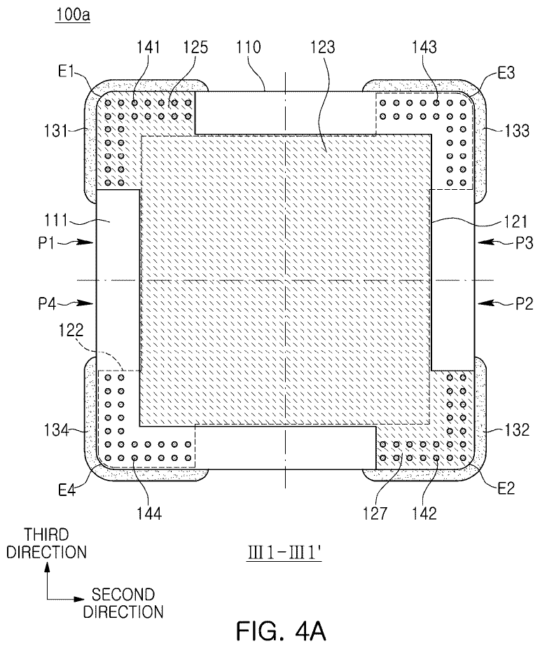

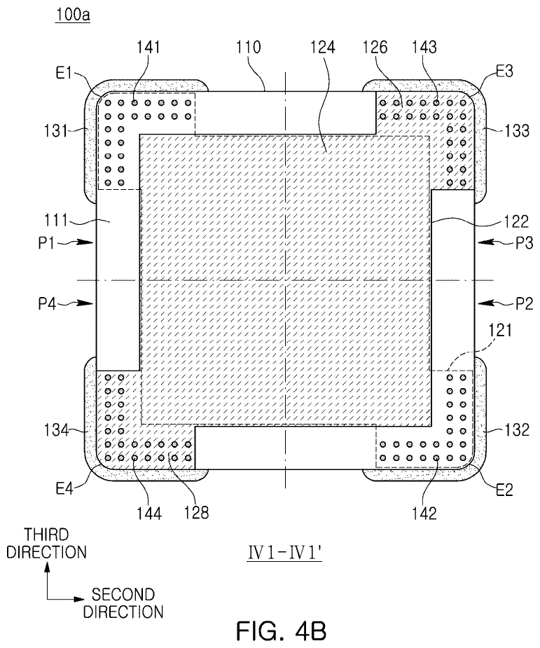

FIG. 4A is a cross-sectional diagram taken along line III1-III1′ in FIG. 1.

FIG. 4B is a cross-sectional diagram taken along line IV1-IV1′ in FIG. 1.

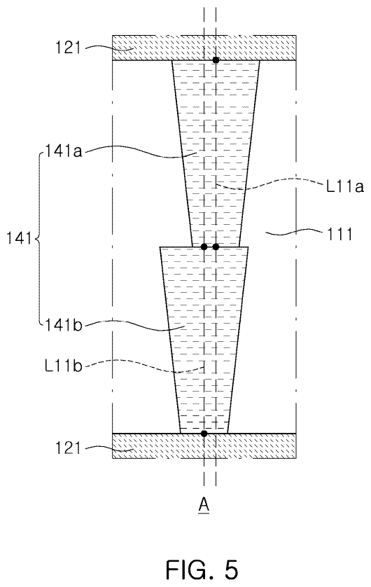

FIG. 5 is an enlarged diagram illustrating region A in FIG. 2.

Hereinafter, a multilayer electronic component 100a according to an embodiment will be described in greater detail with reference to FIGS. 1 to 5. A multilayer ceramic capacitor will be described as an example of a multilayer electronic component, but an embodiment thereof is not limited thereto, and the multilayer ceramic capacitor may be applied to various multilayer electronic components, such as an inductor, a piezoelectric element, a varistor, or a thermistor.

A size of the multilayer electronic component 100a is not limited to any particular example. When the dimensions of the multilayer electronic component 100a in the first to third directions are defined as T, L, and W, respectively, L may be, for example, 0.5 mm to 1.7 mm, W may be, for example, 0.5 mm to 1.7 mm, and T may be, for example, 0.05 mm to 3.5 mm. In an embodiment, each of a ratio of T to L (T/L) and a ratio of T to W (T/W) may satisfy 0.6 or less. Lower limits of the T/L and T/W are not limited to any particular example, and may be, for example, 0.05 or more each. The multilayer electronic component 100a may have, for example, a 0606 size (L=about 0.6 mm, W=about 0.6 mm, T=0.3 mm). According to one example, T, L, and W may refer to the maximum dimensions of the multilayer electronic component 100a in the first to third directions, respectively. A dimension (i.e., T in the first direction, L in the second direction, and/or W in the third direction) of the multilayer electronic component 100a may be measured with a microscope based on a cross-section of the multilayer electronic component 100a. In one example, the dimension (i.e., T in the first direction, L in the second direction, and/or W in the third direction) of the multilayer electronic component 100a may be measured along a corresponding direction of the first to third directions of the multilayer electronic component 100a. An average dimension (i.e., average T in the first direction, average L in the second direction, and/or average W in the third direction) of the multilayer electronic component 100a may be obtained by measuring the corresponding dimension at multiple points, for example, 30 points equally spaced apart from each other, and measuring an average value thereof. A maximum dimension (i.e., maximum T in the first direction, maximum L in the second direction, and/or maximum W in the third direction) of the multilayer electronic component 100a may be obtained by selecting the maximum value among those obtained at multiple points, for example, 30 points equally spaced apart from each other.

The multilayer electronic component 100a according to an embodiment may include a body 110, external electrodes 131, 132, 133, and 134 and connection electrodes 141, 142, 143, and 144.

The shape of the body 110 may not be limited to any particular shape, but as illustrated, the body 110 may have a hexahedral shape or a shape similar to a hexahedral shape. Due to shrinkage of ceramic powder included in the body 110 during a sintering process or polishing of corners, the body 110 may not have an exactly hexahedral shape formed by linear lines but may have a substantially hexahedral shape.

The body 110 may have first and second surfaces 1 and 2 opposing each other in the first direction, third and fourth surfaces 3 and 4 connected to the first and second surfaces 1 and 2 and opposing in the second direction, and fifth and sixth surfaces 5 and 6 connected to the first and second surfaces 1 and 2 and the third and fourth surfaces 3 and 4 and opposing each other in the third direction.

The body 110 may be divided into first to fourth portions P1, P2, P3, and P4. The first to fourth portions P1, P2, P3, and P4 may be distinct from each other by dividing the body 110 into two portions in the second and third directions respectively. For example, referring to FIGS. 4A and 4B, the first portion PI may include a corner E1 at which the third and fifth surfaces meet each other, the second portion P2 may include a corner E2 at which the fourth and sixth surfaces meet each other, the third portion P3 may include a corner E3 at which the fourth and fifth surfaces meet each other, and the fourth portion P4 may include a corner E4 at which the third and sixth surfaces meet each other. Hereinafter, the corner E1 at which the third and fifth surfaces meet may be defined as a first corner, the corner E2 at which the fourth and sixth surfaces meet may be defined as a second corner, the corner E3 at which the fourth and fifth surfaces meet may be defined as a third corner, and the corner E4 at which the third and sixth surfaces meet may be defined as a fourth corner.

The body 110 may include the dielectric layer 111 and the first and second internal electrodes 121 and 122 alternately disposed in the first direction with the dielectric layer 111 interposed therebetween. The plurality of dielectric layers 111 forming the body 110 may be in a sintered state, and boundaries between adjacent dielectric layers 111 may be integrated with each other such that boundaries therebetween may not be distinct without using a scanning electron microscope (SEM).

The dielectric layer 111 may include a perovskite-type compound represented by ABO₃ as a main component, for example. The perovskite compound represented by ABO₃ may be BaTiO₃, (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1), Ba(Ti_{1-y}Zr_{y})O₃ (0<y<1), CaZrO₃, or (Ca₁₋ₓSrₓ)(Zr_{1-y}Ti_{y})O₃ (0<x≤0.5, 0<y≤0.5).

The body 110 may include a first internal electrodes 121 and a second internal electrode 122 alternately disposed with the dielectric layer 111 interposed therebetween. That is, the first internal electrodes 121 and the second internal electrode 122, a pair of electrodes having different polarities, may be disposed to oppose each other with the dielectric layer 111 interposed therebetween. The first internal electrodes 121 and the second internal electrode 122 may be electrically isolated from each other by the dielectric layer 111 interposed therebetween.

The metal included in the internal electrodes 121 and 122 may be one or more of Ni, Cu, Pd, Ag, Au, Pt, Sn, W, Ti and alloys thereof, and may include Ni more preferably, but an embodiment thereof is not limited thereto.

Referring to FIG. 4A, the first internal electrode 121 may include a first main portion 123 overlapping the second internal electrode 122 in the first direction, a first lead portion 125 extending from the first main portion 123, not overlapping the second internal electrode 122 and exposed to at least one surface of the third and fifth surfaces 3 and 5, and a second lead portion 127 extending from the first main portion 123, not overlapping the second internal electrode 122 and exposed to at least one surface of the fourth and sixth surfaces 4 and 6.

The first main portion 123 may have, for example, a flat plate shape perpendicular to the first direction. The first main portion 123 may be disposed in the first to fourth portions P1, P2, P3, and P4. The first main portion 123 may have a rectangular shape, but an embodiment thereof is not limited thereto, and an edge of the first main portion 123 may be inclined or curved with respect to the second or third direction.

The first and second lead portions 125 and 127 may be exposed to external side surfaces of the first and second portions P1 and P2, respectively. Although not illustrated, edges of the first and second lead portions 125 and 127 connected to the first main portion 123 may extend from the first main portion 123 toward an external side surface of the body 110 in an inclined direction with respect to the second or third direction.

Referring to FIG. 4B, the second internal electrode 122 may include a second main portion 124 overlapping the first internal electrode 121 in the first direction, a third lead portion 126 extending from the second main portion 124, not overlapping the first internal electrode 121 and exposed to at least one surface of the fourth and fifth surfaces 4 and 5, and a fourth lead portion 128 extending from the second main portion 124, not overlapping the first internal electrode 121 and exposed to at least one surface of the third and sixth surfaces 3 and 6.

The second main portion 124 may have, for example, a flat plate shape perpendicular to the first direction. The second main portion 124 may be disposed in the first to fourth portions P1, P2, P3, and P4. The second main portion 124 may have a rectangular shape, but an embodiment thereof is not limited thereto, and an edge of the second main portion 124 may be inclined or curved with respect to the second or third direction.

The third and fourth lead portions 126 and 128 may be exposed to external side surfaces of the third and fourth portions P3 and P4, respectively. Although not illustrated, edges of the third and fourth lead portions 126 and 128 connected to the second main portion 124 may extend from the second main portion 124 in a direction inclined with respect to the second or third direction toward an external side surface of the body 110.

An average thickness of the dielectric layer 111 and the internal electrodes 121 and 122 is not limited to any particular example. The average thickness of the dielectric layer 111 may be, for example, 0.1 μm to 10 μm, 0.1 μm to 5 μm, 0.1 μm to 2μm, or 0.1 μm to 0.4 μm. The average thickness of the internal electrodes 121 and 122may be, for example, 0.1μ m to 3.0 μm, 0.1μ m to 1.0 μm, or 0.1μ m to 0.4μ m.

An average thickness of the dielectric layer 111 and an average thickness of the internal electrodes 121 and 122 may indicate sizes of the dielectric layer 111 and the internal electrodes 121 and 122 in the first direction, respectively. The average thickness of the dielectric layer 111 and the average thickness of the internal electrodes 121 and 122 may be measured by scanning a cross-section in the first and second directions of the body 110 using a scanning electron microscope (SEM) with a magnification of 10,000. More specifically, the average thickness of the dielectric layer 111 may be measured from the thicknesses of the dielectric layer 111 at 30 points at an equal distance in the second direction. Also, the average thickness of internal electrodes 121 and 122 may be measured by measuring the thickness at multiple points of one internal electrode 121 and 122, for example, 30 points at an equal distance in the second direction. The 30 points at an equal distance may be designated in capacitance formation portion Ac. By measuring the average value after performing the average value measurements on ten dielectric layers 111 and ten internal electrodes 121 and 122, respectively, the average thickness of the dielectric layer 111 and the average thickness of the internal electrodes 121 and 122 may be further generalized.

The body 110 may include a capacitance formation portion Ac disposed in the body 110 and including the first and second internal electrodes 121 and 122 alternately disposed with the dielectric layer 111 interposed therebetween, and a first cover portion 112 and a second cover portion 113 disposed on both surfaces of capacitance formation portion Ac opposing each other in the first direction. The cover portions 112 and 113 may be configured similarly to the dielectric layer 111, other than the configuration in which the cover portions 112 and 113 do not include an internal electrode.

An average thickness of the cover portions 112 and 113 may not be limited to any particular example. The average thickness of the cover portions 112 and 113 may be, for example, 40 μm or less, 30 μm or less, or 20 μm or less. The average thickness of cover portions 112 and 113 may be, for example, 5 μm or more, or 10 μm or more. Here, the average thickness of the cover portions 112 and 113 may indicate the average thickness of each of the first cover portion 112 and the second cover portion 113.

The average thickness of the cover portions 112 and 113 may indicate the average size in the first direction of the cover portions 112 and 113, and may be an average value of the first direction size measured at five points at an equal distance in the second direction in a cross-section of the body 110 in the first direction and second direction cut from a center of the body 110 in the third direction.

The first and second external electrodes 131 and 132 may be disposed on the first and second portions P1 and P2, respectively, and may be connected to the first internal electrode 121. The first external electrode 131 may be disposed on at least one surface among the third and fifth surfaces 3 and 5, and may be connected to the first lead portion 125. The second external electrode 132 may be disposed on at least one surface among the fourth and sixth surfaces 4 and 6, and may be connected to the second lead portion 127.

The third and fourth external electrodes 133 and 134 may be disposed on the third and fourth portions P3 and P4, respectively, and may be connected to the second internal electrode 122. The third external electrode 133 may be disposed on at least one surface among the fourth and fifth surfaces 4 and 5, and may be connected to the third lead portion 126. The fourth external electrode 134 may be disposed on at least one of the third and sixth surfaces 3 and 6 and may be connected to the fourth lead portion 128.

For example, the first external electrode 131 may be disposed on the third and fifth surfaces 3 and 5 and may extend to a portion of the first and second surfaces 1 and 2, the second external electrode 132 may be disposed on the fourth and sixth surfaces 4 and 6 and may extend to a portion of the first and second surfaces 1 and 2, the third external electrode 133 may be disposed on the fourth and fifth surfaces 4 and 5 and may extend to a portion of the first and second surfaces 1 and 2, and the fourth external electrode 134 may be disposed on the third and sixth surfaces 3 and 6 and may extend to a portion of the first and second surfaces 1 and 2. However, an embodiment thereof is not limited thereto, and by including the contact electrode described later, the external electrodes 131, 132, 133, and 134 may be disposed only on the first surface and/or the second surfaces 1 and 2.

The types of the external electrodes 131, 132, 133, and 134 are not limited to any particular example, and may have a multilayer structure. The external electrodes 131, 132, 133, and 134 may include, for example, a base electrode layer in contact with the internal electrodes 121 and 122, and a plating layer disposed on the base electrode layer.

The base electrode layer may include, for example, one or more of a sintered electrode layer, a conductive resin layer, and a thin-film electrode layer.

The sintered electrode layer may include a metal and glass. The metal included in the sintered electrode layer may include one or more of Cu, Ni, Pd, Pt, Au, Ag, Pb, and alloys thereof, but an embodiment thereof is not limited thereto. The glass included in the sintered electrode layer may include one or more oxides of Ba, Ca, Zn, Al, B and Si, but an embodiment thereof is not limited thereto.

The conductive resin layer may include metal particles and resin. The second conductive metal included in the conductive resin layer may include one or more of spherical particles and flake-type particles. Here, spherical particles may include shapes not completely spherical, for example, shapes in which the length ratio (major axis/minor axis) between the major axis and the minor axis is 1.45 or higher. Flake-type particles may refer to particles having a flat and elongated shape, and are not limited to any particular example, and for example, a length ratio of the major axis between the minor axis (major axis/minor axis) may be 1.95 or more. The metal particles included in the conductive resin layer may include, for example, one or more of Cu, Ni, Pd, Pt, Au, Ag, Pb, Sn and alloys thereof. The resin included in the conductive resin layer may include, for example, one or more of epoxy resin, acrylic resin and ethyl cellulose.

The conductive resin layer may be formed of a conductive polymer. The conductive polymer may include, for example, one or more of polypyrrole, polyaniline, polythiophene, and PEDOT:PSS.

The thin-film electrode layer may be formed, for example, by using an electrolytic plating method, an electroless plating method, an atomic layer deposition (ALD) method, a chemical vapor deposition (CVD) method, and/or a sputtering method.

The base electrode layer may be, for example, the sintered electrode layer, or may have a form in which the sintered electrode layer and the conductive resin layer are laminated in order, or may have a form in which the thin-film electrode layer and the sintered electrode layer are laminated in order.

The plating layer may include, for example, Ni, Sn, Pd, and/or an alloy thereof, and may include a plurality of layers. The plating layer may be, for example, a Ni plating layer or a Sn plating layer, and may be formed in a form in which the Ni plating layer and the Sn plating layer are formed in order. Also, the plating layer may include a plurality of Ni plating layers and/or a plurality of Sn plating layers.

In the drawing, the multilayer electronic component 100a may have four external electrodes 131, 132, 133, and 134, but an embodiment thereof is not limited thereto, and the number of the external electrodes 131, 132, 133, and 134 or the shape thereof may be varied depending on the shape of the internal electrodes 121 and 122 or other purposes.

The multilayer electronic component 100a may include connection electrodes 141, 142, 143, and 144 disposed in at least one of the first to fourth portions P1, P2, P3, and P4, penetrating the dielectric layer 111 and connecting two first internal electrodes 121 adjacent to each other in the first direction or connecting two second internal electrodes 122 adjacent to each other in the first direction.

For example, the first connection electrode 141 may be disposed in the first portion P1, penetrating the dielectric layer 111 and connecting two first internal electrodes 121 adjacent to each other in the first direction, and the second connection electrode 142 may be disposed in the second portion P2, penetrating the dielectric layer 111 and connecting two first internal electrodes 121 adjacent to each other in the first direction.

The first connection electrode 141 may penetrate a region adjacent to the first corner E1 of the body 110 and may connect two first lead portions 125 adjacent to each other among the plurality of first lead portions 125. The first connection electrode 141 may penetrate the region (hereinafter referred to as the first margin region) in which the third and fifth surfaces 3 and 5 and the second internal electrode 122 are spaced apart from each other between the two first lead portions 125 adjacent to each other in the first direction.

The second connection electrode 142 may penetrate a region adjacent to the second corner E2 of the body 110 and may connect adjacent two second lead portions 127 among the plurality of second lead portions 127. The second connection electrode 142 may penetrate the region (hereinafter referred to as the second margin region) in which the fourth and sixth surfaces 4 and 6 and the second internal electrode 122 are spaced apart from each other between the two second lead portions 127 adjacent to each other in the first direction.

For example, the third connection electrode 143 may be disposed in the third portion P3, penetrating the dielectric layer 111 and connecting two second internal electrodes 122 adjacent to each other in the first direction, and the fourth connection electrode 144 may be disposed in the fourth portion P4, penetrating the dielectric layer 111 and connecting two second internal electrodes 122 adjacent to each other in the first direction.

The third connection electrode 143 may penetrate a region adjacent to the third corner E3 of the body 110 and may connect two third lead portions 126 adjacent to each other among the plurality of third lead portion 126. The third connection electrode 143 may penetrate a region (hereinafter referred to as the third margin region) in which the fourth surface and fifth surface 4 and 5 and the first internal electrode 121 are spaced apart from each other between two third lead portions 126 adjacent to each other in the first direction.

The fourth connection electrode 144 may penetrate a region adjacent to the fourth corner E4 of the body 110 and may connect two fourth lead portions 128 adjacent to each other among the plurality of fourth lead portions 128. The fourth connection electrode 144 may penetrate the region (hereinafter referred to as the fourth margin region) in which the third surface and sixth surface 3 and 6 and the first internal electrode 121 are spaced apart from each other between the two fourth lead portions 128 adjacent to each other in the first direction.

Generally, connection between the internal electrode and the external electrode may be disconnected due to shrinkage of the internal electrode during the sintering process or cracks occurring in the body. As the number of internal electrodes disconnected from the external electrode may increase among the plurality of internal electrodes, capacitance of the multilayer electronic component may decrease.

According to the first embodiment, even when a portion of the internal electrodes 121 and 122 shrinks due to a sintering process and loses contact with the external electrode 131, 132, 133, and 134, the internal electrode may be electrically connected to the external electrode 131, 132, 133, and 134 through the connection electrode 141, 142, 143, and 144 and the internal electrodes 121 and 122 of another layer. Accordingly, reduction in capacitance of the multilayer electronic component 100a is reduced may be prevented.

Also, the connection electrode 141, 142, 143, and 144 may be disposed in the margin region, such that the phenomenon in which the margin region is recessed due to a step difference formed by a difference in the number of laminations of the internal electrodes 121 and 122 between the margin region and the capacitance formation portion Ac or due to external stress may be prevented.

According to the first embodiment, in at least one of the first to fourth connection electrodes 141, 142, 143, and 144, a plurality of via electrodes may be laminated in the first direction, and via electrodes adjacent to each other among a plurality of via electrodes may be shifted from each other in a direction perpendicular to the first direction. For example, the first connection electrode 141 may have a plurality of first via electrodes 141a and 141b laminated in the first direction, the second connection electrode 142 may have a plurality of second via electrodes 142a and 142b laminated in the first direction, the third connection electrode 143 may have a plurality of third via electrodes 143a and 143b laminated in the first direction, and the fourth connection electrode 144 may have a plurality of fourth via electrodes (not illustrated) laminated in the first direction.

Referring to FIG. 5, a configuration in which a plurality of via electrodes 141a, 141b are shifted from each other in a direction perpendicular to the first direction may indicate that, in the cross-section in the first direction and third direction of the body 110, a virtual line L11a connecting ½ points of the upper surface and the lower surface of the first via electrode 141a and a virtual line L11b connecting ½ points of the upper surface and the lower surface of another adjacent first via electrode 141b may not coincide with each other. For example, the virtual line L11a connecting ½ points of the upper surface and the lower surface of the first via electrode 141a and the virtual line L11b connecting ½ points of the upper surface and the lower surface of another adjacent first via electrode 141b may range from greater than 0 to equal to or less than 50% of the width of the upper surface of the first via electrode 141b.

The connection electrodes 141, 142, 143, and 144 may be formed, for example, in a process of laminating two dielectric sheets in which vias are formed. In this case, the vias formed in each dielectric sheet may not be perfectly aligned with each other, and accordingly, the two laminated via electrodes may be shifted from each other in a direction perpendicular to the first direction. Differently from the general method of forming a connection electrode by drilling or punching and processing a hole in the body after sintering, in the first embodiment, the connection electrodes 141, 142, 143, and 144 may be formed by laminating dielectric sheets having vias, cracks formed in the body 110 due to drilling may be prevented.

In an embodiment, a plurality of the connection electrodes 141, 142, 143, and 144 penetrating the same dielectric layer 111 may be disposed. The plurality of connection electrodes 141, 142, 143, and 144 penetrating the same dielectric layer 111 may be arranged in the second and third directions. Here, the plurality of connection electrodes penetrating the same dielectric layer may refer to the plurality of first to fourth connection electrodes 141, 142, 143, and 144 penetrating the same dielectric layer, respectively.

For example, the plurality of connection electrodes 141, 142, 143, and 144 disposed on the same level may be arranged in the second and third directions. Here, the plurality of connection electrodes disposed on the same level may refer to the plurality of first to fourth connection electrodes 141, 142, 143, and 144 disposed on the same level, respectively.

The number of connection electrodes 141, 142, 143, and 144 penetrating the same dielectric layer 111 is not limited to any particular example and may be varied depending on the size of the multilayer electronic component 100a or the sizes of the connection electrodes 141, 142, 143, and 144. For example, the number of connection electrodes 141, 142, 143, and 144 penetrating the same dielectric layer 111 may be 5 or more and 300 or less. Here, the number of connection electrodes 141, 143 may indicate the number of each of the first to fourth connection electrodes 141, 142, 143, and 144.

In an embodiment, referring to FIG. 5, a width of the upper surface of the via electrodes 141a and 141b may be greater than a width of the lower surface of the via electrodes 141a and 141b. The via formed in the dielectric sheet may be formed, for example, by irradiating the dielectric sheet with a laser. In this case, the energy amount of the laser light may decrease from one surface of the dielectric sheet to which the laser is irradiated to the other surface. Accordingly, a width of the via electrodes 141a and 141b may gradually decrease from the upper surface of the via electrodes 141a and 141b to the lower surface of the via electrodes 141a and 141b.

In the drawing, the cross-section of the via electrodes 141a and 141b may have a trapezoidal shape, but an embodiment thereof is not limited thereto, and by controlling the irradiation conditions of the laser, the cross-section of the via electrodes 141a and 141b may have various shapes, and sidewalls of the via electrodes 141a and 141b may also have curved surfaces.

A maximum width of the via electrodes 141a and 141b may be varied depending on the size of the multilayer electronic component 100a or the thickness of the dielectric layer 111. The maximum width of the via electrodes 141a and 141b is not limited to any particular example, and may be 0.03 μm to 10 μm.

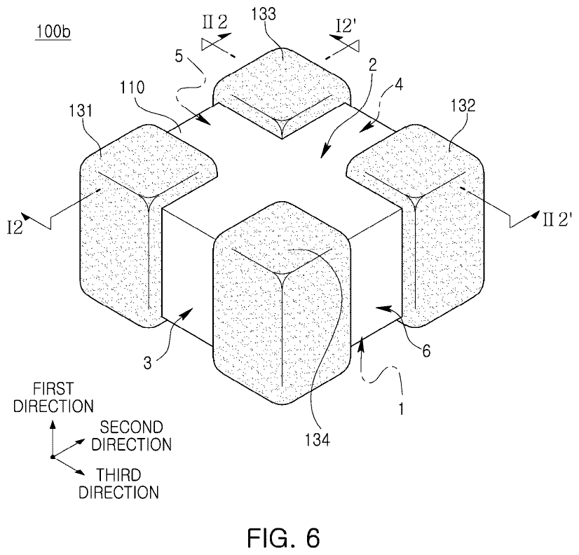

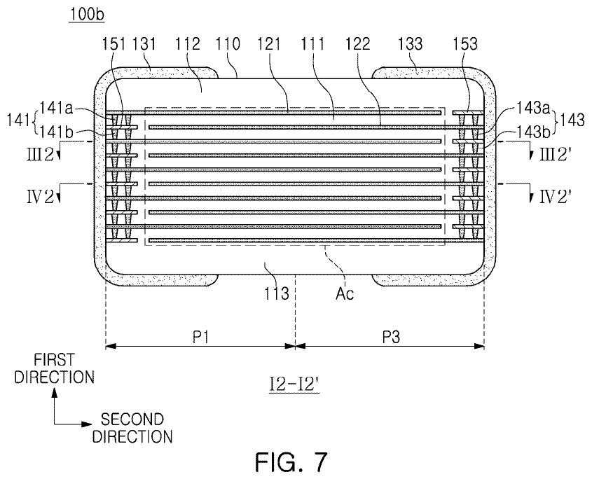

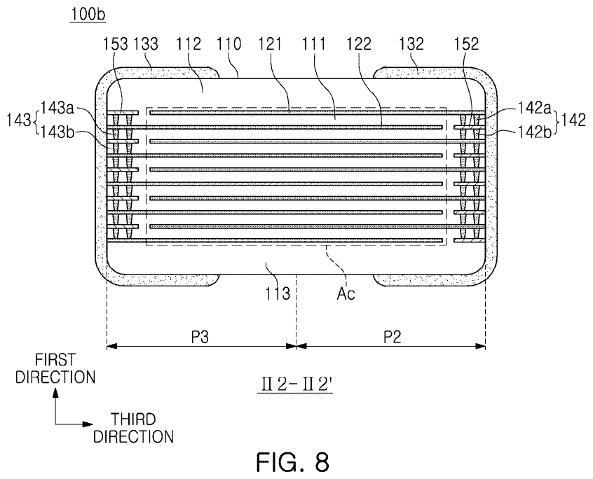

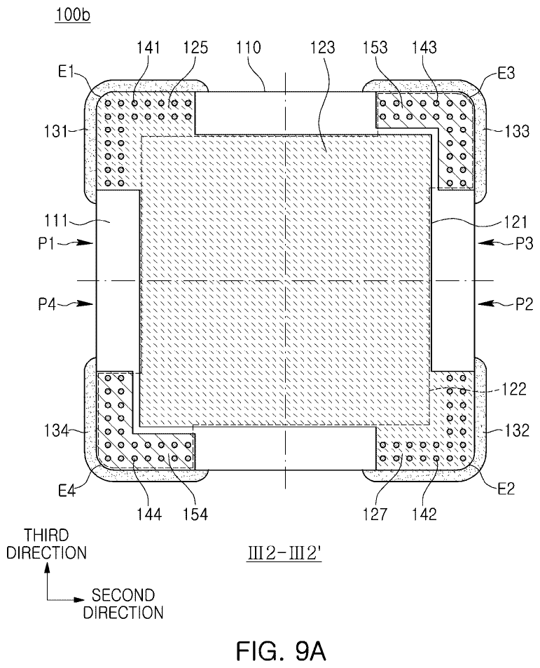

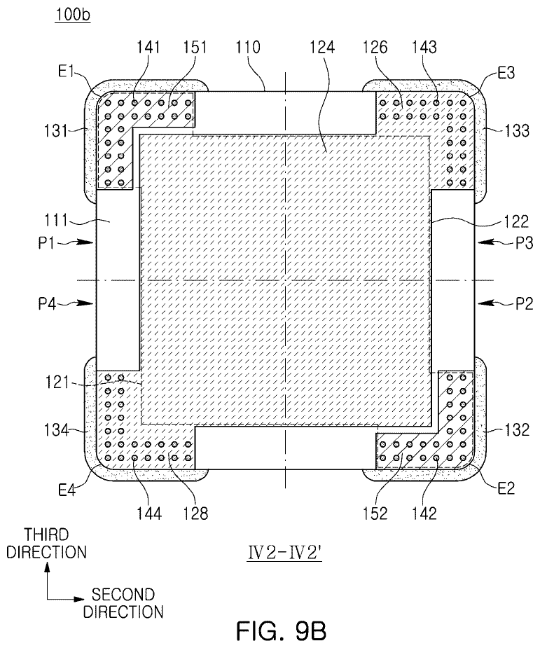

FIG. 6 is a perspective diagram illustrating a multilayer electronic component according to a first modified example of a first embodiment. FIG. 7 is a cross-sectional diagram taken along line I2-I2′ in FIG. 6. FIG. 8 is a cross-sectional diagram taken along line II2-II2′ in FIG. 6. FIG. 9A is a cross-sectional diagram taken along line III2-III2′ in FIG. 7. FIG. 9B is a cross-sectional diagram taken along line IV2-IV2′ in FIG. 7.

Hereinafter, a multilayer electronic component 100b according to a first modified example of the first embodiment will be described with reference to FIGS. 6 to 9B. The same/similar reference numerals are used for the same/similar components as those of the multilayer electronic component 100a described in FIGS. 1 to 5, and overlapping descriptions will not be provided.

The multilayer electronic component 100b may include auxiliary electrodes 151, 152, 153, and 154 disposed in at least one of the first to fourth portions of P1, P2, P3, and P4 and disposed between two via electrodes adjacent to each other in the first direction among the plurality of via electrodes.

For example, the first auxiliary electrode 151 may be disposed in the first portion P1 and may be disposed between two first via electrodes 141a and 141b laminated in the first direction, the second auxiliary electrode 152 may be disposed in the second portion P2 and may be disposed between two second via electrodes 142a and 142b laminated in the first direction, the third auxiliary electrode 153 may be disposed in the third portion P3 and may be disposed between two third via electrodes 143a and 143b laminated in the first direction, and the fourth auxiliary electrode 154 may be disposed in the fourth portion P4 and may be disposed between two fourth via electrodes (not illustrated) laminated in the first direction.

The first auxiliary electrode 151 may be exposed to at least one surface among the third and fifth surfaces 3 and 5 and may be connected to the first external electrode 131, the second auxiliary electrode 152 may be exposed to at least one surface among the fourth and sixth surfaces 4 and 6 and may be connected to the second external electrode 132, the third auxiliary electrode 153 may be exposed to at least one surface among the fourth and fifth surfaces 4 and 5 and may be connected to the third external electrode 133, and the fourth auxiliary electrode 154 may be exposed to at least one surface among the third and sixth surfaces 3 and 6 and may be connected to the fourth external electrode 134. However, an embodiment thereof is not limited thereto, and the auxiliary electrodes 151, 152, 153, and 154 may be spaced apart from the third surface to the sixth surface 3, 4, 5, and 6.

The first and second auxiliary electrodes 151 and 152 may be disposed at the first and second corners E1 and E2, respectively, and may extend in the second and third directions toward the third and fourth portions P3 and P4. The first and second auxiliary electrodes 151 and 152 may be disposed only at the first and second portions P1 and P2, respectively, but an embodiment thereof is not limited thereto.

The third and fourth auxiliary electrodes 153 and 154 may be disposed at the third and fourth corners E3 and E4, respectively, and may extend in the second and third directions toward the first and second portions P1 and P2. The third and fourth auxiliary electrodes 153 and 154 may be disposed only at the third and fourth portions P3 and P4, respectively, but an embodiment thereof is not limited thereto.

The first and second auxiliary electrodes 151 and 152 may be disposed on substantially the same plane as the second internal electrode 122 and may be spaced apart from the second internal electrode 122, and the third and fourth auxiliary electrodes 153 and 154 may be disposed on substantially the same plane as the first internal electrode 121 and may be spaced apart from the first internal electrode 121.

A first auxiliary electrode 151 may be connected to a plurality of first connection electrodes 141 penetrating the same dielectric layer 111, a second auxiliary electrode 152 may be connected to a plurality of second connection electrodes 142 penetrating the same dielectric layer 111, a third auxiliary electrode 153 may be connected to a plurality of third connection electrodes 143 penetrating the same dielectric layer 111, and a fourth auxiliary electrode 154 may be connected to a plurality of fourth connection electrodes 144 penetrating the same dielectric layer 111.

By disposing the auxiliary electrodes 151, 152, 153, and 154, a step difference formed due to a difference in the number of laminates between the margin region and the capacitance formation portion Ac may be suppressed, and accordingly, the margin region may be prevented from being recessed. Also, by appropriately disposing the auxiliary electrodes 151, 152, 153, and 154, even when the via electrodes included in the connection electrodes 141, 142, 143, and 144 are overly misaligned, electrical connection between the adjacent internal electrodes 121 and 122 may be assured.

The metal included in the auxiliary electrodes 151, 152, 153, and 154 may be one or more of Ni, Cu, Pd, Ag, Au, Pt, Sn, W, Ti, and alloys thereof. The auxiliary electrodes 151, 152, 153, and 154 may include the same metal as that of the internal electrodes 121 and 122, but an embodiment thereof is not limited thereto.

The distance in the second direction between the first internal electrode 121 and the third auxiliary electrode 153 may be 10% to 90% of the distance between the first internal electrode 121 and the fourth surface 4, and the distance in the third direction between the first internal electrode 121 and the third auxiliary electrode 153 may be 10% to 90% of the distance between the first internal electrode 121 and the fifth surface 5. This may be applied to the distance between the first internal electrode 121 and the fourth auxiliary electrode 154, and the distance between the second internal electrode 122 and the first and second auxiliary electrodes 151 and 152.

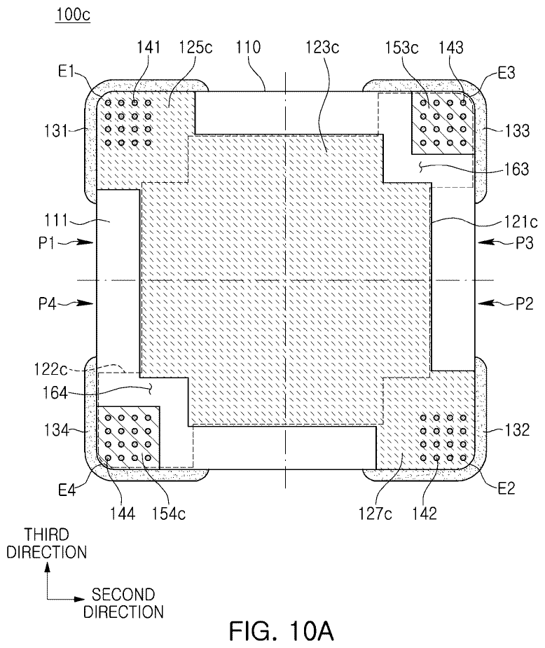

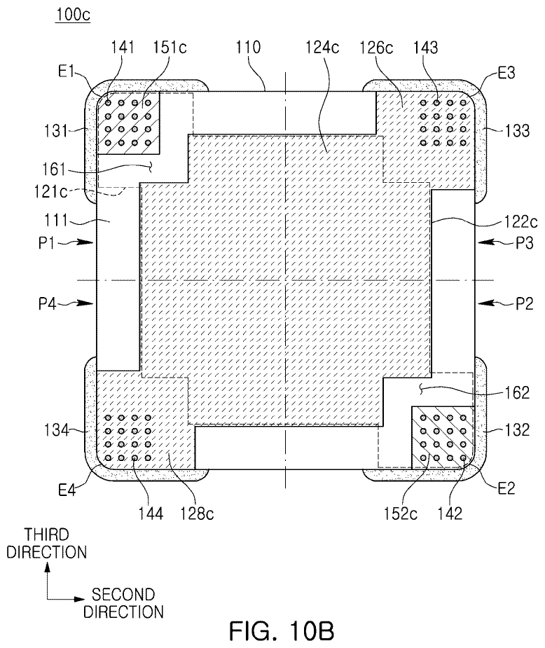

FIGS. 10A and 10B are cross-sectional diagrams illustrating a multilayer electronic component according to a second modified example of a first embodiment of the present disclosure, corresponding to FIGS. 9A and 9B.

Hereinafter, a multilayer electronic component 100c according to a second modified example of the first embodiment will be described with reference to FIGS. 10A and 10B. The same/similar reference numerals are used for the components of the multilayer electronic components 100a and 100b described in FIGS. 1 to 9B, and overlapping descriptions will not be provided.

Referring to FIG. 10A, a first internal electrode 121c may include a first main portion 123c, a first lead portion 125c extending from the first main portion 123c and exposed to at least one of the third and fifth surfaces 3 and 5, and a second lead portion 127c extending from the first main portion 123c and exposed to at least one of the fourth and sixth surfaces 4 and 6.

Referring to FIG. 10B, the second internal electrode 122c may include a second main portion 124c, a third lead portion 126c extending from the second main portion 124c and exposed to at least one surface of the fourth and fifth surfaces 4 and 5, and a fourth lead portion 128c extending from the second main portion 124c and exposed to at least one surface of the third and sixth surfaces 3 and 6.

The multilayer electronic component 100c may include auxiliary electrodes 151c, 152c, 153c, and 154c disposed between via electrodes adjacent to each other in the first direction among a plurality of via electrodes.

For example, the first to fourth auxiliary electrodes 151c, 152c, 153c, and 154c may be disposed in the first to fourth portions P1, P2, P3, and P4, respectively, and may be connected to the first to fourth connection electrodes 141, 142, 143, and 144 and the first to fourth external electrodes 131, 132, 133, and 134. However, an embodiment thereof is not limited thereto, and the first to fourth auxiliary electrodes 151c, 152c, 153c, and 154c may be spaced apart from the first to fourth external electrodes 131, 132, 133, and 134.

The second internal electrode 122c may include first and second cutout portions 161 and 162 disposed in the first and second portions P1 and P2, respectively, and the first internal electrode 121c may include third and fourth cutout portions 163 and 164 disposed in the third and fourth portions P3 and P4, respectively. Here, the cutout portions 161, 162, 163, and 164 may be defined as regions in which the internal electrodes 121c, 122c are not disposed among internal regions defined by virtual lines formed by extending the long edges of the main portions 123c and 124c.

For example, the first and second cutout portions 161 and 162 may be disposed at both corners of the second internal electrode 122c disposed in the first and second portions P1 and P2, respectively, and third and fourth cutout portions 163 and 164 may be disposed at both corners of the first internal electrode 121c disposed in the third and fourth portions P3 and P4, respectively. The first and second main portions 123c and 124c may be provided, for example, in a +shape by the cutout portions 161, 162, 163, and 164.

In an embodiment, the first to fourth cutout portions 161, 162, 163, and 164 may have shapes corresponding to the shapes of the auxiliary electrodes 151c, 152c, 153c, and 154c. For example, as illustrated in FIGS. 10A and 10B, the first to fourth cutout portions 161, 162, 163, and 164 may have a rectangular shape corresponding to the shapes of the auxiliary electrodes 151c, 152c, 153c, and 154c. However, an embodiment thereof is not limited thereto, and the auxiliary electrodes 151c, 152c, 153c, and 154c may have various shapes such as an arc shape, and the first to fourth cutout portions 161, 162, 163, and 164 may also have various shapes corresponding to the shapes of the auxiliary electrodes 151c, 152c, 153c, and 154c. A portion of the auxiliary electrodes 151c, 152c, 153c, and 154c may be disposed in the cutout portions 161, 162, 163, and 164.

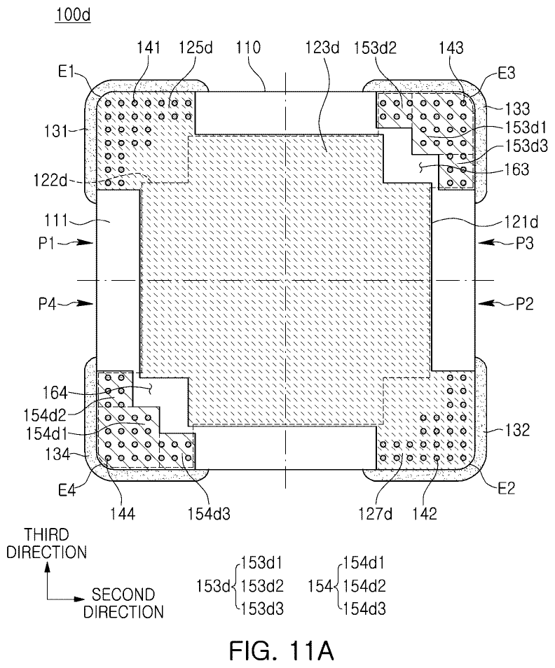

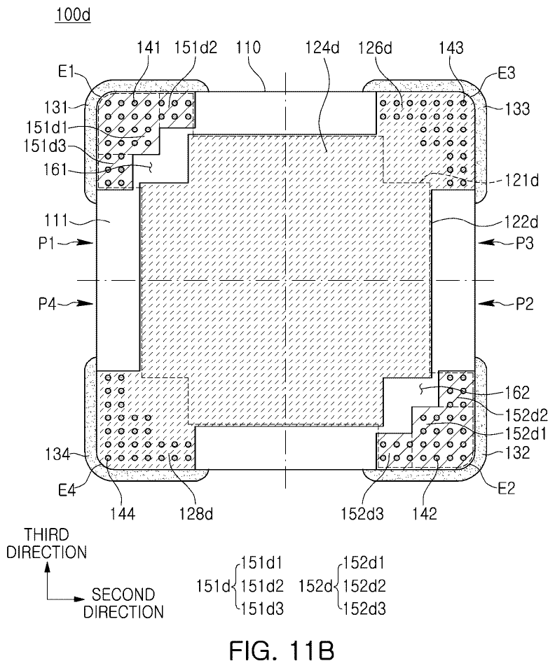

FIGS. 11A and 11B are cross-sectional diagrams illustrating a multilayer electronic component according to a third modified example of a first embodiment of the present disclosure, corresponding to FIGS. 9A and 9B.

Hereinafter, a multilayer electronic component 100d according to a third modified example of the first embodiment will be described with reference to FIGS. 11A and 11B. The same/similar reference numerals are used for the components of the multilayer electronic components 100a, 100b, and 100c described in FIGS. 1 to 10B, and overlapping descriptions will not be provided.

Referring to FIG. 11A, a first internal electrode 121d may include a first main portion 123d, a first lead portion 125d extending from the first main portion 123d and exposed to at least one of the third and fifth surfaces 3 and 5, and a second lead portion 127d extending from the first main portion 123d and exposed to at least one of the fourth and sixth surfaces 4 and 6.

Referring to FIG. 10B, the second internal electrode 122d may include a second main portion 124d, a third lead portion 126d extending from the second main portion 124d and exposed to at least one surface of the fourth and fifth surfaces 4 and 5, and a fourth lead portion 128d extending from the second main portion 124d and exposed to at least one surface of the third and sixth surfaces 3 and 6.

The multilayer electronic component 100d may include auxiliary electrodes 151d, 152d, 153d, and 154d disposed in at least one of the first to fourth portions P1, P2, P3, and P4 and disposed between via electrodes adjacent to each other in the first direction among the plurality of via electrodes.

For example, the first to fourth auxiliary electrodes 151d, 152d, 153d, and 154d may be disposed in the first to fourth portions P1, P2, P3, and P4, respectively, and may be connected to first to fourth connection electrodes 141, 142, 143, and 144 and the first to fourth external electrodes 131, 132, 133, and 134.

The first auxiliary electrode 151d may include a first connection portion 151d1 exposed to a portion of the third surface 3 and a portion of the fifth surface 5, a first extension portion 151d2 extending from the first connection portion 151d1 toward the third portion P3 and having a smaller dimension in the third direction than the first connection portion 151d1, and a second extension portion 151d3 extending from the first connection portion 151d1 toward the fourth portion P4 and having a smaller dimension in the second direction than the first connection portion 151d1.

The second auxiliary electrode 152d may include a second connection portion 152d1 exposed to a portion of the fourth surface 4 and a portion of the sixth surface 6, a third extension portion 152d2 extending from the second connection portion 152d1 toward the third portion P3 and having a smaller dimension in the second direction than the second connection portion 152d1, and a fourth extension portion 152d3 extending from the second connection portion 152d1 toward the fourth portion P4 and having a smaller dimension in the third direction than the second connection portion 152d1.

The third auxiliary electrode 153d may include a third connection portion 153d1 exposed to a portion of the fourth surface 4 and a portion of the fifth surface 5, a fifth extension portion 153d2 extending from the third connection portion 153d1 toward the first portion P1 and having a smaller dimension in the third direction than the third connection portion 153d1, and a sixth extension portion 153d3 extending from the third connection portion 153d1 toward the second portion P2 and having a smaller dimension in the second direction than the third connection portion 153d1.

The fourth auxiliary electrode 154d may include a fourth connection portion 1541 exposed to a portion of the third surface 3 and a portion of the sixth surface 6, a seventh extension portion 154d2 extending from the fourth connection portion 154d1 toward the first portion P1 and having a smaller dimension in the second direction than the fourth connection portion 154d1, and an eighth extension portion 154d3 extending from the fourth connection portion 154d1 toward the second portion P2 and having a smaller dimension in the third direction than the fourth connection portion 154d1.

The multilayer electronic component 100d may effectively present the margin region from being recessed due to external stress by including the first to eighth extension portions 151d2, 151d3, 152d2, 152d3, 153d2, 153d3, 154d2, and 154d3.

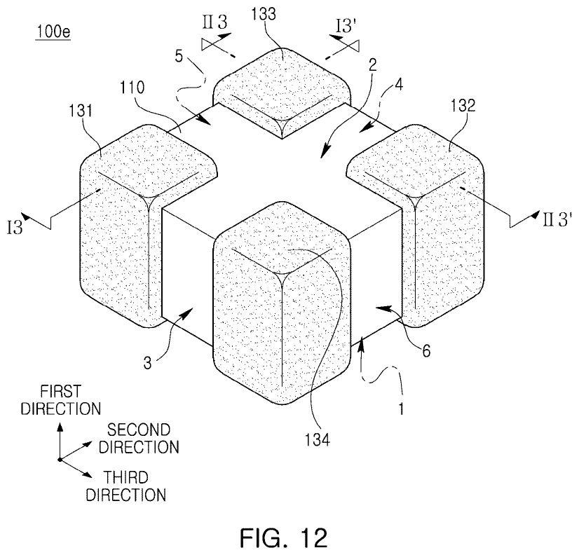

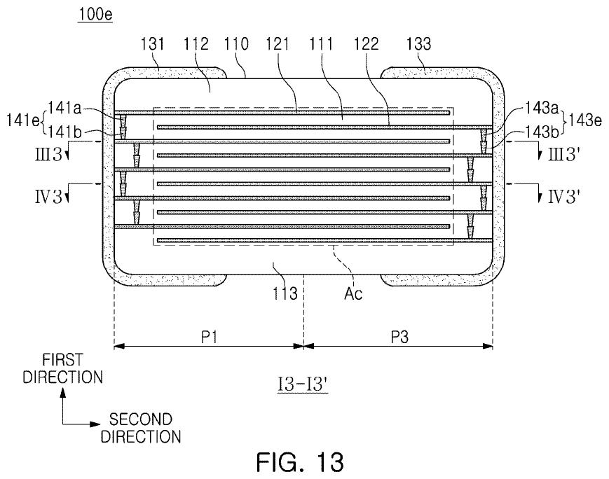

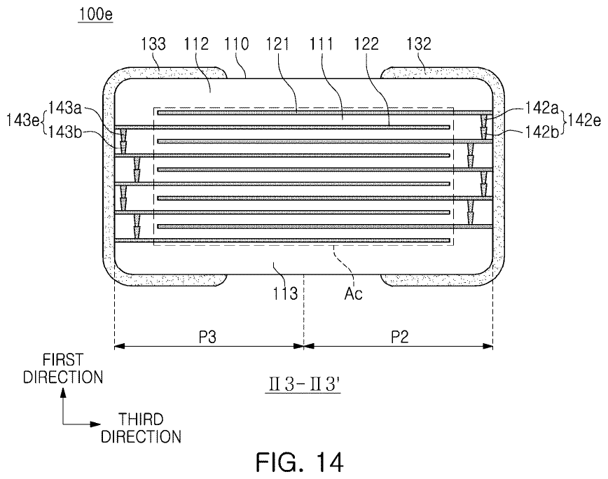

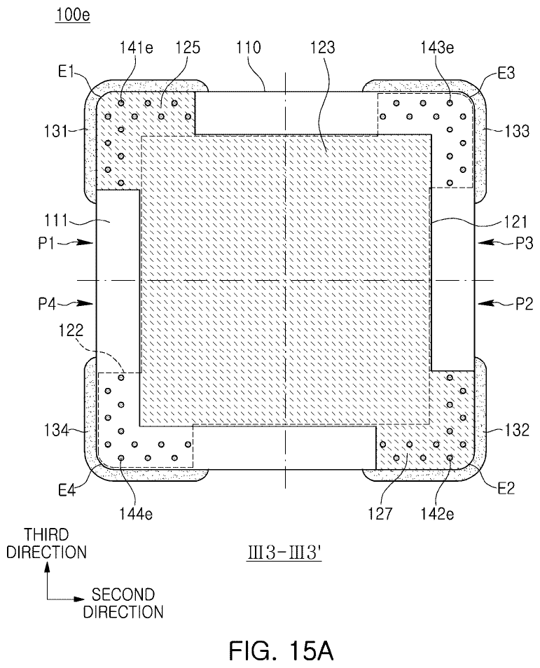

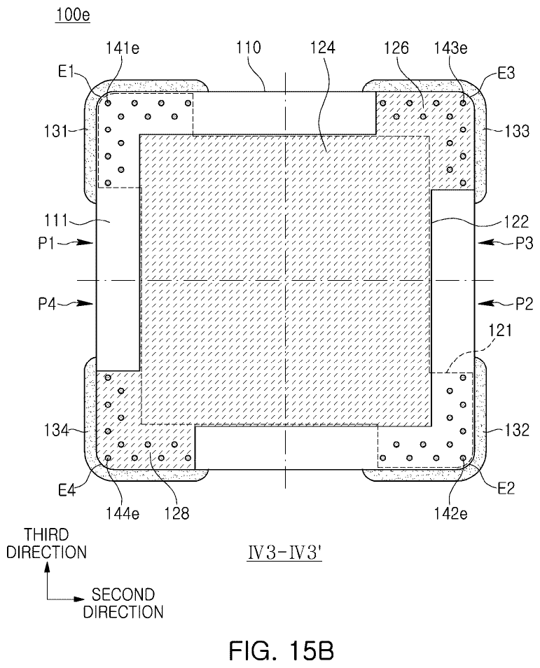

FIG. 12 is a perspective diagram illustrating a multilayer electronic component according to a fourth modified example of a first embodiment of the present disclosure. FIG. 13 is a cross-sectional diagram taken along line I3-I3′ in FIG. 12. FIG. 14 is a cross-sectional diagram taken along line II3-II3′ in FIG. 12. FIG. 15A is a cross-sectional diagram taken along line III3-III3′ in FIG. 13. FIG. 15B is a cross-sectional diagram taken along line IV3-IV3′ in FIG. 13.

Hereinafter, a multilayer electronic component 100e according to a fourth modified example of the first embodiment will be described with reference to FIGS. 12 and 15B. The same/similar reference numerals are used for the same/similar components of the multilayer electronic component 100a described in FIGS. 1 to 5, and overlapping descriptions will not be provided.

According to the fourth modified example of the first embodiment, two connection electrodes 141e, 142e, 143e, 144e adjacent to each other in the first direction may be shifted from each other in a direction perpendicular to the first direction.

For example, two first connection electrodes 141e adjacent to each other in the first direction may be shifted from each other in a direction perpendicular to the first direction, two second connection electrodes 142e adjacent to each other in the first direction may be shifted from each other in a direction perpendicular to the first direction, two third connection electrodes 143e adjacent to each other in the first direction may be shifted from each other in a direction perpendicular to the first direction, and two fourth connection electrodes 144e adjacent to each other in the first direction may be shifted from each other in a direction perpendicular to the first direction.

Here, two first connection electrodes 141e adjacent to each other in the first direction may refer to, in the cross-section in the first direction and second direction of the body 110 or the cross-section in the first direction and third direction of the body, a first connection electrode 141e in contact with the upper surface of the same first internal electrode 121, and another first connection electrode 141e in contact with the lower surface of the same first internal electrode 121.

Also, when a plurality of first connection electrodes 141e in contact with the upper and lower surfaces are provided, two first connection electrodes 141e adjacent to each other in the first direction may refer to a first connection electrode 141e in contact with the upper surface of the same first internal electrode 121, and the other first connection electrode 141e the most adjacent to the first connection electrode 141e in the second or third direction among the plurality of first connection electrode 141e in contact with the lower surface of the same first internal electrode 121.

Also, the configuration in which two adjacent first connection electrodes 141e are shifted from each other may indicate that, in the cross-section in the first direction and second direction of the body 110 or the cross-section in the first direction and third direction of the body 110, a virtual line connecting ½ points of upper and lower surfaces of one first connection electrode 141e and a virtual line connecting ½ points of upper and lower surfaces of another first connection electrode 141e do not coincide with each other.

According to the third modified example of the first embodiment, two first connection electrodes 141e adjacent to each other in the first direction may be shifted from each other such that the first connection electrodes 141e may be dispersed in the first margin region. Accordingly, mechanical strength of the multilayer electronic component 100e may be effectively improved regardless of the number of first connection electrodes 141e.

Since the second to fourth connection electrodes 142e, 143e, and 144e may have a structure similar to the first connection electrode 141e, a detailed description of the second to fourth connection electrodes 142e, 143e, and 144e will not be provided. The description of the first connection electrode 141e described above may be applied to the second to fourth connection electrodes 142e, 143e, and 144e, unless otherwise indicated.

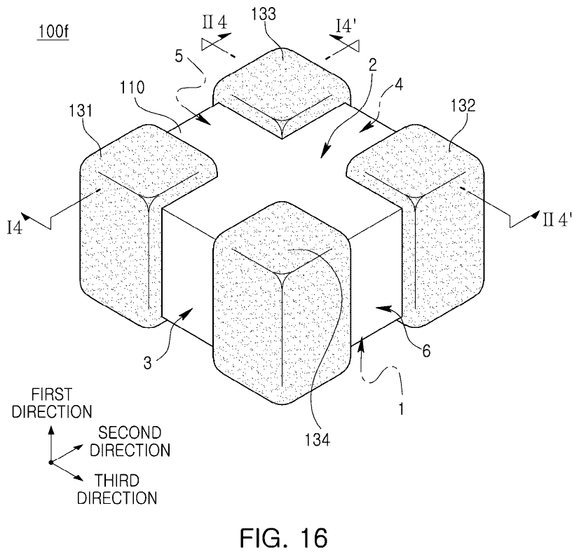

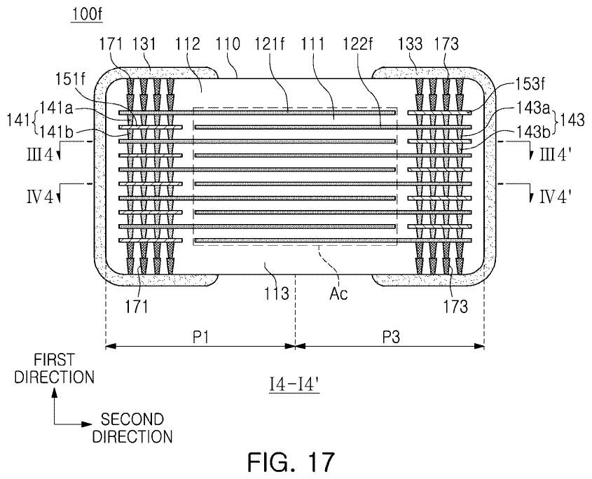

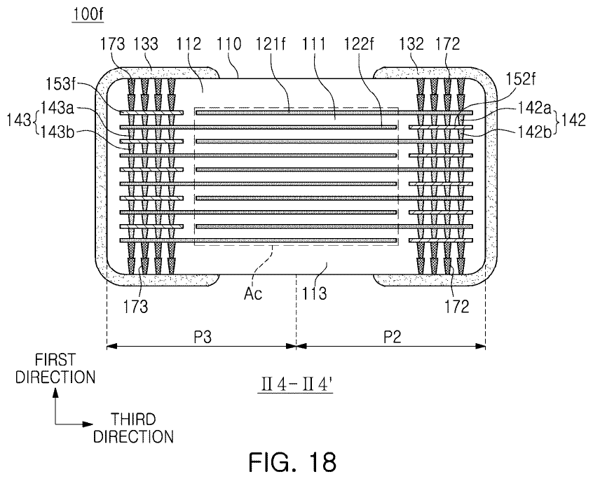

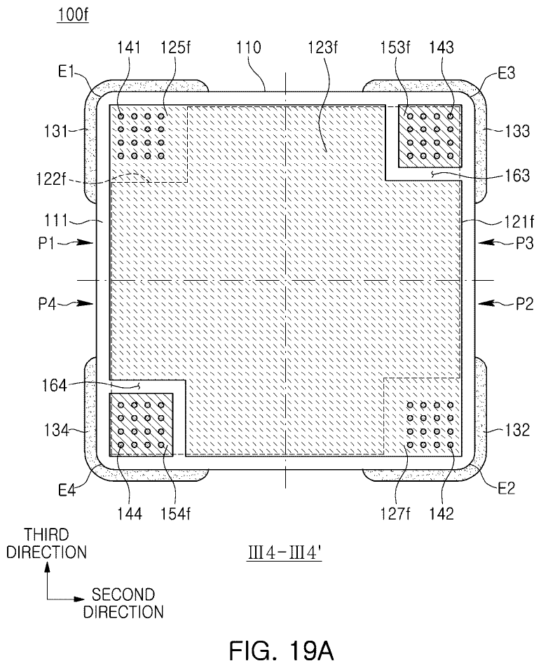

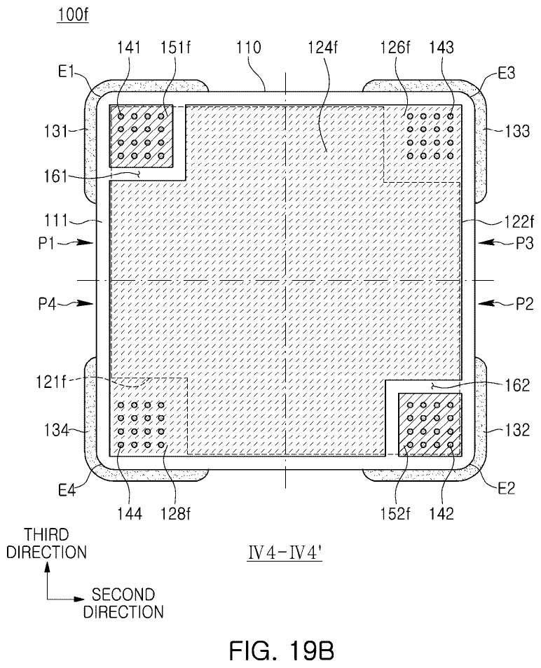

FIG. 16 is a perspective diagram illustrating a multilayer electronic component according to a fifth modified example of a first embodiment. FIG. 17 is a cross-sectional diagram taken along line I4-I4′ in FIG. 16. FIG. 18 is a cross-sectional diagram taken along line II4-II4′ in FIG. 16. FIG. 19A is a cross-sectional diagram taken along line III4-III4′ in FIG. 17. FIG. 19B is a cross-sectional diagram taken along line VI4-VI4′ in FIG. 17.

Hereinafter, a multilayer electronic component 100f according to the fifth modified example of the first embodiment will be described with reference to FIGS. 16 and 19B. The same/similar reference numerals are used for the components of the multilayer electronic components 100a, 100b, and 100c described in FIGS. 1 to 10B, and overlapping descriptions will not be provided.

Referring to FIG. 19A, a first internal electrode 121f may include a first main portion 123f overlapping the second internal electrode 122f in the first direction, a first lead portion 125f disposed in the first portion P1, extending from the first main portion 123f and not overlapping the second internal electrode 122f, and a second lead portion 127f disposed in the second portion P2, extending from the first main portion 123f and not overlapping the second internal electrode 122f.

Referring to FIG. 19B, the second internal electrode 122f may include a second main portion 124f disposed in a first direction overlapping the first internal electrode 121f, a third lead portion 126f disposed in a third portion P3, extending from the second main portion 124f and not overlapping the first internal electrode 121f, and a fourth lead portion 128f disposed in a fourth portion P4, extending from the second main portion 124f and not overlapping the first internal electrode 121f.

The multilayer electronic component 100f may include auxiliary electrodes 151f, 152f, 153f, and 154f disposed between via electrodes adjacent to each other in the first direction among a plurality of via electrodes.

For example, the first to fourth auxiliary electrodes 151f, 152f, 153f, and 154f may be disposed in the first to fourth cutout portions 161, 162, 163, and 164, respectively, and may be connected to the first to fourth connection electrodes 141, 142, 143, and 144. The first to fourth auxiliary electrodes 151f, 152f, 153f, and 154f may be spaced apart from the first to fourth external electrodes 131, 132, 133, and 134.

The first to fourth auxiliary electrodes 151f, 152f, 153f, and 154f may be disposed in the first to fourth cutout portions 161, 162, 163, and 164, respectively, but an embodiment thereof is not limited thereto, and a portion of the auxiliary electrodes 151f, 152f, 153f, and 154f may be disposed externally of the cutout portions 161, 162, 163, and 164.

The first to fourth auxiliary electrodes 151f, 152f, 153f, and 154f may have a shape corresponding to the shape of the first to fourth cutout portions 161, 162, 163, and 164, respectively, and may have, for example, a quadrangular shape, but an embodiment thereof is not limited thereto.

The multilayer electronic component 100f may include contact electrodes 171, 172, and 173 disposed in at least one of the first to fourth portions P1, P2, P3, and P4, penetrating the cover portions 112 and 113, and connecting a first internal electrode 121f disposed in an outermost region with respect to the first direction to a first or second external electrode 131, 132, or connecting a second internal electrode 122f disposed in an outermost region with respect to the first direction to third or fourth external electrodes 133 and 134.

For example, the first contact electrode 171 may be disposed in the first portion P1, may penetrate the cover portions 112 and 113, and may connect the first internal electrode 121f or the first auxiliary electrode 151 disposed in an outermost region with respect to the first direction to the first external electrode 131. The second contact electrode 172 may be disposed in the second portion P2, may penetrate the cover portions 112 and 113, and may connect the first internal electrode 121f or the second auxiliary electrode 152f disposed in an outermost region with respect to the first direction to the second external electrode 132.

The third contact electrode 173 may be disposed in the third portion P3, may penetrate the cover portions 112 and 113, and may connect the second internal electrode 122f or the third auxiliary electrode 153f disposed in an outermost region with respect to the first direction to the third external electrode 133. The fourth contact electrode (not illustrated) may be disposed in the fourth portion P4, may penetrate the cover portions 112 and 113, and may connect the second internal electrode 122f or the fourth auxiliary electrode 154f disposed in an outermost region with respect to the first direction to the fourth external electrode 134. The first to fourth contact electrodes may be disposed in the first and second cover portions 112 and 113, respectively.

The contact electrodes 171, 172, and 173 may be formed by laminating two or more layers of sheets for forming a cover portion in which a via is formed. Accordingly, the contact electrodes 171, 172, and 173 may have a shape similar to that of the connection electrode. In an embodiment, the contact electrodes 171, 172, and 173 may include a plurality of through-electrodes laminated in a first direction, and two through-electrodes adjacent to each other among the plurality of through-electrodes may be shifted from each other in a direction perpendicular to the first direction. In the drawing, a contact electrode in which two through-electrodes may be laminated is illustrated, but the number of laminates of the through-electrodes included in the contact electrodes 171, 172, and 173 is not limited to any particular example, and may be varied depending on the number of sheets for forming the cover portion

The first to fourth external electrodes 131, 132, 133, and 134 may be disposed on the first surface and/or the second surface 1, 2, respectively, for contact with the contact electrode. For example, the first to fourth external electrodes 131, 132, 133, and 134 may be disposed on the upper surface and/or the lower surface of the body 110 and may extend to the side surface of the body 110. The contact electrode may connect the internal electrodes 121 and 122 or the auxiliary electrodes 151f, 152f, 153f, and 154f disposed in an outermost region with respect to the first direction and the region extending to the first surface 1 and/or second surface 2 of the external electrode 131, 132, 133, and 134, thereby increasing a current path of the multilayer electronic component 100f and reducing equivalent series resistance (ESR).

Since the electrical connection between the internal electrodes 121f and 122f and the external electrodes 131, 132, 133, and 134 may be assured through the contact electrode, the first and second internal electrodes 121f and 122f and the first to fourth auxiliary electrodes 151f, 152f, 153f, and 154f may be spaced apart from the third to sixth surfaces 3, 4, 5, and 6. Accordingly, the deterioration of moisture resistance reliability of the multilayer electronic component 100f may be prevented.

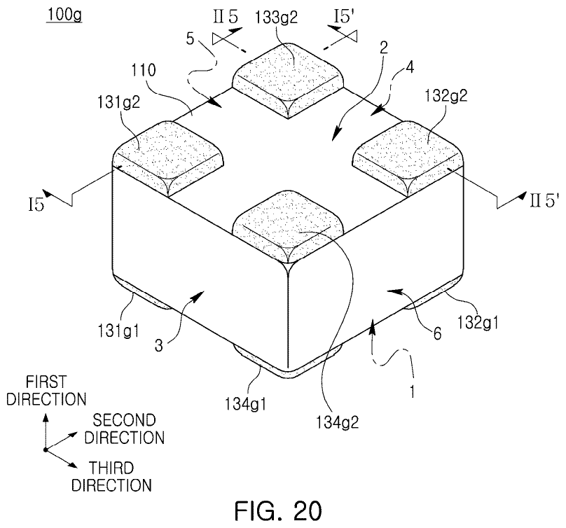

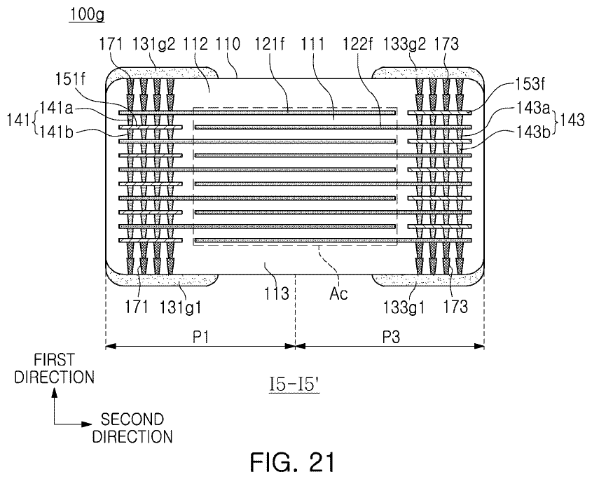

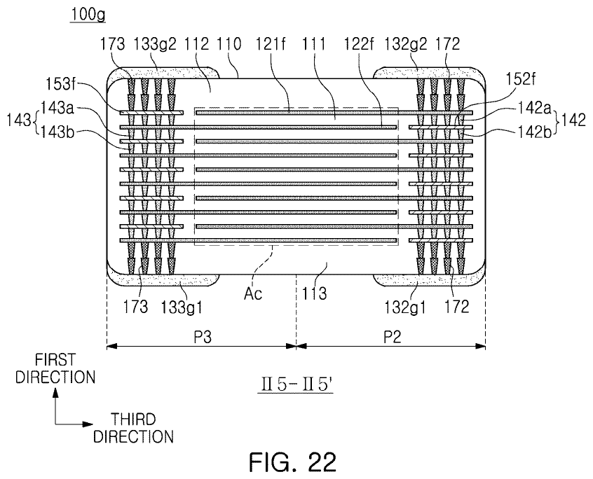

FIG. 20 is a perspective diagram illustrating a multilayer electronic component according to a sixth modified example of a first embodiment of the present disclosure. FIG. 21 is a cross-sectional diagram taken along line I5-I5′ in FIG. 20. FIG. 22 is a cross-sectional diagram taken along line II5-II5′ in FIG. 20.

Hereinafter, a multilayer electronic component 100g according to the sixth modified example of the first embodiment will be described with reference to FIGS. 20 to 22. The same/similar reference numerals are used for the components of the multilayer electronic component 100f described in FIGS. 16 to 19B, and overlapping descriptions will not be provided.

The first external electrodes 131g1 and 131g2, the second external electrodes 132g1 and 132g2, the third external electrodes 133g1 and 133g2, and the fourth external electrodes 134g1 and 134g2 may be disposed on the first and second surfaces 1 and 2, respectively. The first to fourth external electrodes 131g1, 132g1, 133g1, and 134g1 disposed on the first surface 1 and the first to fourth external electrodes 131g2, 132g2, 133g2, and 134g2 disposed on the second surface 2 may be spaced apart from each other. That is, the external electrode of the multilayer electronic component 100g may have a lower electrode form.

The first external electrodes 131g1 and 131g2, the second external electrodes 132g1 and 132g2, the third external electrodes 133g1 and 133g2, and the fourth external electrode 134g1 and 134g2 may not extend from the third to sixth surfaces 3, 4, 5, and 6, respectively, but an embodiment thereof is not limited thereto, and the first external electrodes 131g1 and 131g2, the second external electrodes 132g1 and 132g2, the third external electrodes 133g1 and 133g2, and/or the fourth external electrode 134g1 and 134g2 may extend from the third to sixth surfaces 3, 4, 5, and 6, respectively.

Since the multilayer electronic component 100g may assure electrical connection between the internal electrode and the external electrode through the contact electrodes 171, 172, and 173, the first and second internal electrodes 121f and 122f and the auxiliary electrodes 151f, 152f, 153f, and 154f may be spaced apart from the third surface to the sixth surface 3, 4, 5, and 6. Also, the external electrode may have a lower electrode form disposed on the first and second surfaces 1 and 2, such that capacitance and warpage strength per unit volume of the multilayer electronic component 100g may be improved.

Meanwhile, in the drawing, a lower electrode form in which external electrodes are disposed on the first and second surfaces 1 and 2, respectively, but an embodiment thereof is not limited thereto, and the first to fourth external electrodes may be disposed on one of the first and second surfaces 1 and 2 and may not be disposed on the other surface. That is, the first to fourth external electrodes may be disposed on the first surface 1 and may not be disposed on the second surface 2, or may be disposed on the second surface 2 and may not be disposed on the first surface 1.

### (Second Embodiment)

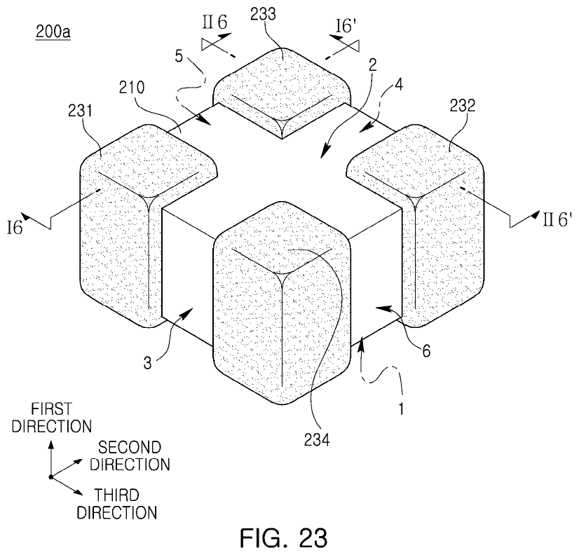

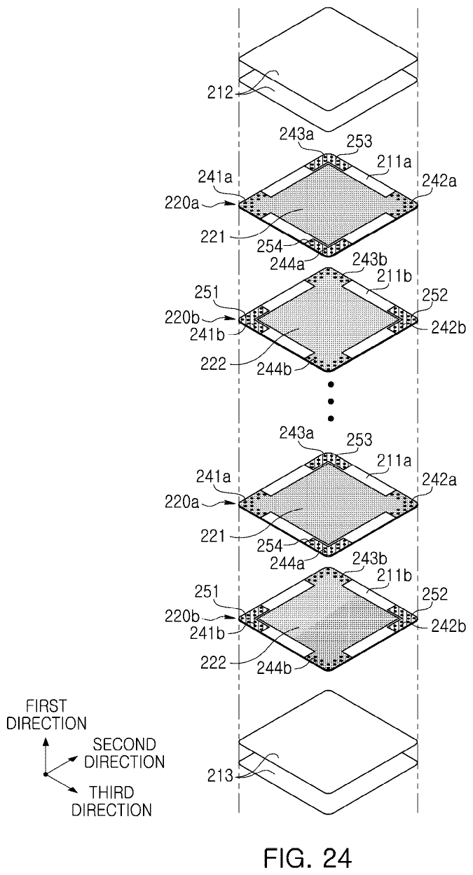

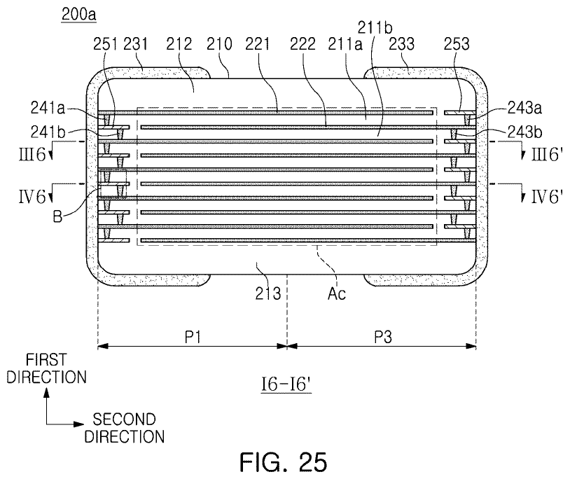

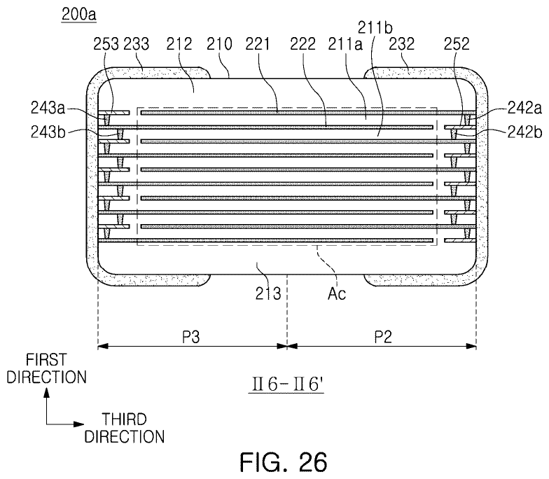

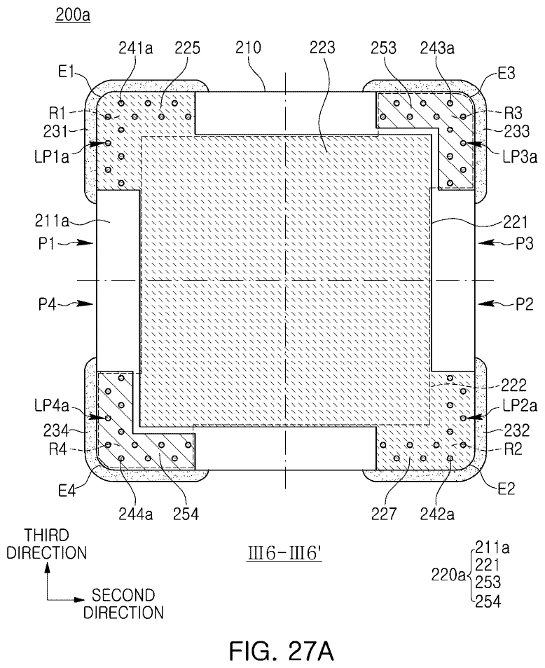

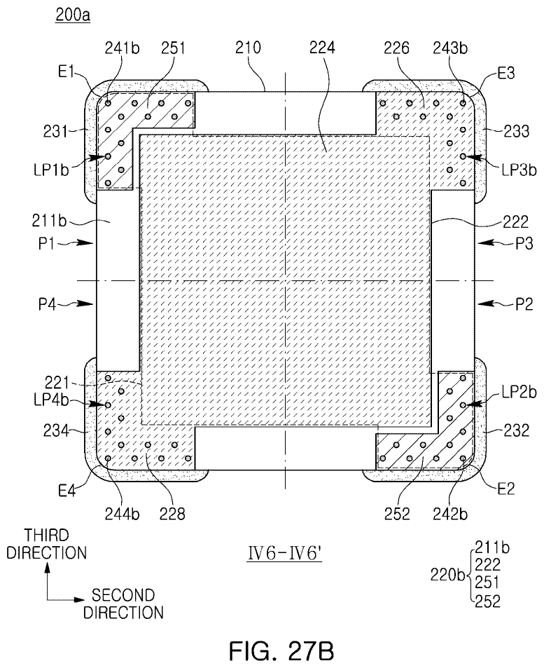

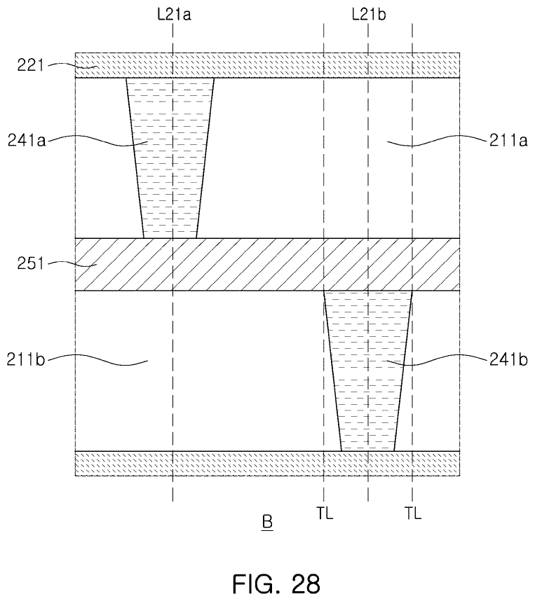

FIG. 23 is a perspective diagram illustrating a multilayer electronic component according to a second embodiment of the present disclosure. FIG. 24 is an exploded perspective diagram illustrating a body of a multilayer electronic component according to a second embodiment of the present disclosure. FIG. 25 is a cross-sectional diagram taken along line I6-I6′ in FIG. 23. FIG. 26 is a cross-sectional diagram taken along line II6-II6′ in FIG. 23. FIG. 27A is a cross-sectional diagram taken along line III6-III6′ in FIG. 25. FIG. 27B is a cross-sectional diagram taken along line IV6-IV6′ in FIG. 25; FIG. 28 is an enlarged diagram illustrating region B in FIG. 25.

Hereinafter, a multilayer electronic component 200a according to a second embodiment will be described with reference to FIGS. 23 to 28. The same/similar reference numerals are used for the components of the multilayer electronic components 100a and 100b described in FIGS. 1 to 9B, and overlapping descriptions will not be provided.

A multilayer electronic component 200a according to a second embodiment may include a body 210, external electrodes 231, 232, 233, and 234, and via electrodes 241a, 241b, 242a, 242b, 243a, 243b, 244a, and 244b.

The body 210 may have first and second surfaces 1 and 2 opposing each other in the first direction, third and fourth surfaces 3 and 4 connected to the first and second surfaces 1 and 2 and opposing in the second direction, and fifth and sixth surfaces 5 and 6 connected to the first and second surfaces 1 and 2 and the third and fourth surfaces 3 and 4 and opposing each other in the third direction.

The body 210 may be divided into first to fourth portions P1, P2, P3, and P4. The first to fourth portions P1, P2, P3, and P4 may be distinct from each other by dividing the body 110 into two portions in the second and third directions respectively. For example, referring to FIGS. 27A and 28B, the first portion P1 may include a corner E1 at which the third and fifth surfaces meet each other, the second portion P2 may include a corner E2 at which the fourth and sixth surfaces meet each other, the third portion P3 may include a corner E3 at which the fourth and fifth surfaces meet each other, and the fourth portion P4 may include a corner E4 at which the third and sixth surfaces meet each other. Hereinafter, the corner E1 at which the third and fifth surfaces meet may be defined as a first corner, the corner E2 at which the fourth and sixth surfaces meet may be defined as a second corner, the corner E3 at which the fourth and fifth surfaces meet may be defined as a third corner, and the corner E4 at which the third and sixth surfaces meet may be defined as a fourth corner.

The body 210 may include a first internal electrode layer 220a and a second internal electrode layer 220b alternately disposed in the first direction. The body 210 may include a capacitance formation portion Ac disposed in the body 210, and including first and second internal electrodes 221, 222 alternately disposed with the first dielectric layer 21 la or the second dielectric layer 211b interposed therebetween and forming capacitance, and cover portions 212 and 213 disposed on both surfaces of the capacitance formation portion Ac opposing each other in the first direction.

The first internal electrode layer 220a may include a first dielectric layer 211a, a first internal electrode 221 disposed on the first dielectric layer 211a, and third and fourth auxiliary electrodes 253 and 254 disposed on the first dielectric layer 211a, spaced apart from the first internal electrode 221 and disposed on the third and fourth portions P3 and P4, respectively.

The second internal electrode layer 220b may include a second dielectric layer 211b, a second internal electrode 222 disposed on the second dielectric layer 211b, and first and second auxiliary electrodes 251 and 252 disposed on the second dielectric layer 211b, spaced apart from the second internal electrode 222 and disposed in the first and second portions P1 and P2, respectively.

Referring to FIG. 27A, the first internal electrode 221 may include a first main portion 223 overlapping the second internal electrode 222 in the first direction, a first lead portion 225 extending from the first main portion 223, not overlapping the second internal electrode 222 and exposed to at least one surface among the third and fifth surfaces 3 and 5, and a second lead portion 227 extending from the first main portion 223, not overlapping the second internal electrode 222 and exposed to at least one surface among the fourth and sixth surfaces 4 and 6.

Referring to FIG. 27B, the second internal electrode 222 may include a second main portion 224 overlapping the first internal electrode 221 in the first direction, a third lead portion 226 extending from the second main portion 224, not overlapping the first internal electrode 221 and exposed to at least one surface among the fourth and fifth surfaces 4 and 5, and a fourth lead portion 228 extending from the second main portion 224, not overlapping the first internal electrode 221 and exposed to at least one surface among the third and sixth surfaces 3 and 6.

The first auxiliary electrode 251 may be disposed between two first lead portions 225 adjacent to each other among the plurality of first lead portion 225, the second auxiliary electrode 252 may be disposed between two second lead portions 227 adjacent to each other among the plurality of second lead portion 227, the third auxiliary electrode 253 may be disposed between two third lead portions 226 adjacent to each other among the plurality of third lead portion 226, and the fourth auxiliary electrode 254 may be disposed between two fourth lead portions 228 adjacent to each other among the plurality of fourth lead portion 228.

The first auxiliary electrode 251 may be exposed to at least one surface among the third and fifth surfaces 3 and 5 and may be connected to the first external electrode 231, the second auxiliary electrode 252 may be exposed to at least one surface among the fourth and sixth surfaces 4 and 6 and may be connected to the second external electrode 232, the third auxiliary electrode 253 may be exposed to at least one surface among the fourth and fifth surfaces 4 and 5 and connected to the third external electrode 233, and the fourth auxiliary electrode 254 may be exposed to at least one surface among the third and sixth surfaces 3 and 6 and may be connected to the fourth external electrode 234. However, an embodiment thereof is not limited thereto, and the auxiliary electrodes 251, 252, 253, and 254 may be spaced apart from the third surface to the sixth surface 3, 4, 5, and 6.

The first and second auxiliary electrodes 251 and 252 may be disposed on the first and second corners E1 and E2, respectively, and may extend in the second and third directions toward the third and fourth portions P3 and P4. The first and second auxiliary electrodes 251 and 252 may be disposed only on the first and second portions P1 and P2, respectively, but an embodiment thereof is not limited thereto.

The third and fourth auxiliary electrodes 253 and 254 may be disposed on the third and fourth corners E3 and E4, respectively, and may extend in the second and third directions toward the first and second portions P1 and P2. The third and fourth auxiliary electrodes 253 and 254 may be disposed only on the third and fourth portions P3 and P4, respectively, but an embodiment thereof is not limited thereto.

The first and second external electrodes 231, 232 may be disposed on the first and second portions P1 and P2, respectively, and may be connected to the first internal electrode 221. The first external electrode 231 may be disposed on at least one surface of the third and fifth surfaces 3 and 5, for example, and may be connected to the first lead portion 225. The second external electrode 232 may be disposed on at least one surface of the fourth and sixth surfaces 4 and 6, for example, and may be connected to the second lead portion 227.

The third and fourth external electrodes 233 and 234 may be disposed on the third and fourth portions P3 and P4, respectively, and may be connected to the second internal electrode 222. The third external electrode 233 may be disposed on at least one surface of the fourth and fifth surfaces 4 and 5, for example, and may be connected to the third lead portion 226. The fourth external electrode 234 may be disposed on at least one surface of the third and sixth surfaces 3 and 6, for example, and may be connected to the fourth lead portion 228.

For example, the first external electrode 231 may be disposed on the third and fifth surfaces 3 and 5 and may extend to a portion of the first and second surfaces 1 and 2, the second external electrode 232 may be disposed on the fourth and sixth surfaces 4 and 6 and may extend to a portion of the first and second surfaces 1 and 2, the third external electrode 233 may be disposed on the fourth and fifth surfaces 4 and 5 and may extend to a portion of the first and second surfaces 1 and 2, and the fourth external electrode 234 may be disposed on the third and sixth surfaces 3 and 6 and may extend to a portion of the first and second surfaces 1 and 2. However, an embodiment thereof is not limited thereto, and by including a contact structure described below, the external electrodes 231, 232, 233, and 234 may be disposed only on the first surface 1 and/or the second surface 2.

The external electrodes 231, 232, 233, and 234 may include, for example, a base electrode layer in contact with the internal electrodes 221, 222 and a plating layer disposed on the base electrode layer. The base electrode layer may include, for example, one or more of a firing electrode layer, a conductive resin layer, and a thin-film electrode layer.

The multilayer electronic component 200a according to the second embodiment may include a first via electrode 241a disposed in the first portion P1, penetrating the first dielectric layer 211a and connecting the first internal electrode 221 to the first auxiliary electrode 251, and a second via electrode 241b disposed in the first portion P1, penetrating the second dielectric layer 211b and connecting the first internal electrode 221 to the first auxiliary electrode 251.

The first and second via electrodes 241a and 241b may penetrate regions adjacent to the first corners E1 of the first and second dielectric layers 211a and 211b, respectively, and may connect the first lead portion 225 and the first auxiliary electrode 251 to each other. The first and second via electrodes 241a and 241b may penetrate a margin region between the first lead portion 225 and the first auxiliary electrode 251 in which the third and fifth surfaces 3 and 5 and the capacitance formation portion Ac are spaced apart from each other.

According to the second embodiment, even when a portion of the first internal electrodes 221 shrink due to a sintering process and lose contact with the first external electrode 231, the first internal electrodes may be electrically connected to the first external electrode 231 through the first and second via electrodes 241a and 241b and the first internal electrode 221 of other layers. Accordingly, reduction in capacitance of the multilayer electronic component 200a may be prevented.

According to the second embodiment, the first via electrode 241a and the second via electrode 241b may be shifted from each other in a direction perpendicular to the first direction.

Referring to FIG. 28, the configuration in which the first via electrode 241a and the second via electrode 241b are shifted from each other in a direction perpendicular to the first direction may indicate that, in the cross-section in the first direction and second direction of the body 210, a conceptual line L21a connecting ½ points of the upper and lower surfaces of the first via electrode 241a and a conceptual line L21b connecting ½ points of the upper and lower surfaces of the second via electrode 241b may not coincide with each other.

Since the first via electrode 241a and the second via electrode 241b are misaligned with each other, the via electrodes 241a and 241b may be dispersed in the margin region. Accordingly, the margin region may be prevented from being recessed due to a difference in density between the region in which the via electrodes 241a and 241b are disposed and the region in which the via electrodes 241a and 241b are not disposed, or external stress. Also, since the via electrodes 241a and 241b are dispersed in the margin region, mechanical strength of the multilayer electronic component 200a may be effectively improved regardless of the number of via electrodes 241a and 241b.

In an embodiment, the first via electrode 241a and the second via electrode 241b may not overlap each other in the first direction. When the first via electrode 241a and the second via electrode 241b are shifted from each other, the effect of improvement in mechanical strength of the multilayer electronic component 200a intended in embodiments may be exhibited, but when the first via electrode 241a and the second via electrode 241b are disposed to not overlap each other in the first direction, the effect of improvement in mechanical strength may be prominent.

Referring to FIG. 28, the configuration in which the first via electrode 241a and the second via electrode 241b do not overlap each other in the first direction may indicate that a conceptual line TL in the first direction in contact with the second via electrode 241b at a point at which a width of the second via electrode 241b is maximum may not intersect the first via electrode 241a.

In an embodiment, a plurality of the first via electrode 241a penetrating the same first dielectric layer 211a may be disposed, and the plurality of first via electrodes 241a penetrating the same first dielectric layer 211a may be arranged in the second and third directions. For example, the plurality of first via electrodes 241a disposed on the same level may be arranged in the second and third directions.

Similarly, a plurality of the second via electrode 241b penetrating the same second dielectric layer 211b may be disposed, and the plurality of second via electrodes 241b penetrating the same second dielectric layer 211b may be arranged in the second and third directions. For example, the plurality of second via electrodes 241b disposed on the same level may be arranged in the second and third directions.

Referring to FIGS. 27A and 27B, the plurality of first via electrodes 241a penetrating the same first dielectric layer 211a may be arranged in a staggered manner with respect to the second and third directions, thereby forming a first grid pattern LP1a, and the plurality of second via electrodes 241b penetrating the same second dielectric layer 211b may be arranged in a staggered manner with respect to the second and third directions, thereby forming a second grid pattern LP1b.

The first grid pattern LP1a and the second grid pattern LP1b may be alternately disposed in the body 210 with the first internal electrode 221 or the first auxiliary electrode 251 interposed therebetween. The first grid pattern LP1a and the second grid pattern LP1b may include a plurality of first and second via electrodes 241a and 241b arranged in a zigzag pattern, and may not overlap each other in the first direction, thereby effectively improving mechanical strength of the multilayer electronic component 200a.

In an embodiment, the first dielectric layer 211a may include a first region R1 disposed between two first via electrodes 241a adjacent to each other in the second or third direction among the plurality of first via electrodes 241a, and the plurality of second via electrodes 241b may overlap the first region R1.

In an embodiment, a width of the upper surface of the first via electrode 241a may be greater than a width of the lower surface of the first via electrode 241a, and a width of the upper surface of the second via electrode 241b may be greater than a width of the lower surface of the second via electrode 241b. The width of the first via electrode 241a may gradually decrease from the upper surface of the first via electrode 241a toward the lower surface of the first via electrode 241a, for example, and the width of the second via electrode 241b may gradually decrease from the upper surface of the second via electrode 241b toward the lower surface of the second via electrode 241b.

The second to fourth portions P2, P3, and P4 may also include via electrodes having a form similar to that of the first and second via electrodes 241a and 241b disposed in the first portion P1.

The multilayer electronic component 200a may include a third via electrode 242a disposed in the second portion P2, penetrating the first dielectric layer 211a and connecting the first internal electrode 221 to the second auxiliary electrode 252, and a fourth via electrode 242b disposed in the second portion P2, penetrating the second dielectric layer 211b and connecting the first internal electrode 221 to the second auxiliary electrode 252. The third via electrode 242a and the fourth via electrode 242b may be shifted from each other in a direction perpendicular to the first direction.

The multilayer electronic component 200a may include a fifth via electrode 243a disposed in the third portion P3, penetrating the first dielectric layer 211a and connecting the second internal electrode 222 to the third auxiliary electrode 253, and a sixth via electrode 243b disposed in the third portion P3, penetrating the second dielectric layer 211b and connecting the second internal electrode 222 to the third auxiliary electrode 253. The fifth via electrode 243a and the sixth via electrode 243b may be shifted from each other in a direction perpendicular to the first direction.

The multilayer electronic component 200a may include a seventh via electrode 244a disposed in the fourth portion P4, penetrating the first dielectric layer 211a and connecting the second internal electrode 222 to the fourth auxiliary electrode 254, and an eighth via electrode 244b disposed in the fourth portion P4, penetrating the second dielectric layer 211b and connecting the second internal electrode 222 to the fourth auxiliary electrode 254. The seventh via electrode 244a and the eighth via electrode 244b may be shifted from each other in a direction perpendicular to the first direction.

Referring to FIGS. 27A and 27B, a plurality of third via electrodes 242a penetrating the same first dielectric layer 211a may be arranged in a staggered manner with respect to the second and third directions and may form a third grid pattern LP2a, and a plurality of fourth via electrodes 242b penetrating the same second dielectric layer 211b may be arranged in a staggered manner with respect to the second and third directions and may form a fourth grid pattern LP2b. The third grid pattern LP2a and the fourth grid pattern LP2b may include a plurality of third and fourth via electrodes 242a and 242b arranged in a zigzag pattern, respectively, and may not overlap each other in the first direction.

In an embodiment, the first dielectric layer 211a may include a second region R2 disposed between two third via electrodes 242a adjacent to each other in the second or third direction among the plurality of third via electrodes 242a, and the plurality of fourth via electrodes 242b may overlap the second region R2.

The plurality of fifth via electrodes 243a penetrating the same first dielectric layer 211a may be arranged in a staggered manner with respect to the second and third directions, and may form a fifth grid pattern LP3a, and the plurality of sixth via electrodes 243b penetrating the same second dielectric layer 211b may be arranged in a staggered manner with respect to the second and third directions, and may form a sixth grid pattern LP3b. The fifth grid pattern LP3a and the sixth grid pattern LP3b may include a plurality of fifth and sixth via electrodes 243a and 243b arranged in a zigzag pattern, respectively, and may not overlap each other in the first direction.

In an embodiment, the first dielectric layer 211a may include a third region R3 disposed between two fifth via electrodes 243a adjacent to each other in the second or third direction among the plurality of fifth via electrodes 243a, and the plurality of sixth via electrode 243b may overlap the third region R3.

The plurality of seventh via electrodes 244a penetrating the same first dielectric layer 211a may be arranged in a staggered manner with respect to the second and third directions and may form a seventh grid pattern LP4a, and the plurality of eighth via electrodes 244b penetrating the same second dielectric layer 211b may be arranged in a staggered manner with respect to the second and third directions and may form an eighth grid pattern LP4b. The seventh grid pattern LP4a and the eighth grid pattern LP4b may include a plurality of seventh and eighth via electrodes 244a, 244b arranged in a zigzag pattern, respectively, and may not overlap each other in the first direction.

In an embodiment, the first dielectric layer 211a may include a fourth region R4 disposed between two seventh via electrodes 244a adjacent to each other in the second or third direction among the plurality of seventh via electrodes 244a, and the plurality of eighth via electrodes 244b may overlap the fourth region R4.

Hereinafter, detailed descriptions of the third to eighth via electrodes 242a, 242b, 243a, 243b, 244a, and 244b will not be provided. However, the description of the first and second via electrodes 241a and 242b may be applied to the third to eighth via electrodes 242a, 242b, 243a, 243b, 244a, and 244b, unless otherwise indicated.

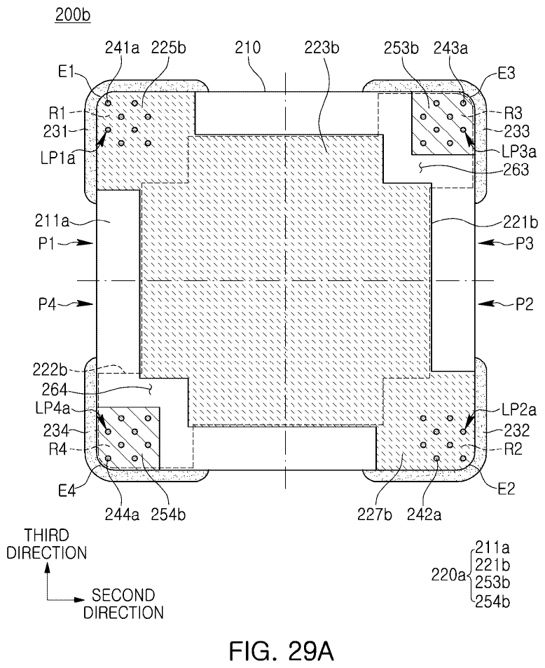

FIGS. 29A and 29B are cross-sectional diagrams illustrating a multilayer electronic component according to a first modified example of a second embodiment of the present disclosure, corresponding to FIGS. 27A and 27B.

Hereinafter, a multilayer electronic component 200b according to a first modified example of the second embodiment will be described with reference to FIGS. 29A and 29B. The same/similar reference numerals are used for the same/similar components of the multilayer electronic component 100c and 200a described in FIGS. 10A and 10B and FIGS. 23 to 28, and overlapping descriptions will not be provided.

Referring to FIG. 29A, a first internal electrode 221b may include a first main portion 223b, a first lead portion 225b extending from the first main portion 223b and exposed to at least one of the third and fifth surfaces 3 and 5, and a second lead portion 227b extending from the first main portion 223b and exposed to at least one of the fourth and sixth surfaces 4 and 6.

Referring to FIG. 29B, the second internal electrode 222b may include a second main portion 224b, a third lead portion 226b extending from the second main portion 224b and exposed to at least one surface of the fourth and fifth surfaces 4 and 5, and a fourth lead portion 228b extending from the second main portion 224b and exposed to at least one surface of the third and sixth surfaces 3 and 6.

The second internal electrode 222b may include first and second cutout portions 261 and 262 disposed in the first and second portions P1 and P2, respectively, and the first internal electrode 221b may include third and fourth cutout portions 263 and 264 disposed in the third and fourth portions P3 and P4, respectively. Here, the cutout portions 261, 262, 263, and 264 may be defined as regions in which the internal electrodes 221b and 222b are not disposed among the internal regions defined by conceptual formed by lines extending the long edges of the main portions 223b and 224b.

For example, the first and second cutout portions 261 and 262 may be disposed at both corners of the second internal electrode 222b disposed in the first and second portions P1 and P2, respectively, and the third and fourth cutout portions 263 and 264 may be disposed at both corners of the first internal electrode 221b disposed in the third and fourth portions P3 and P4, respectively. The first and second main portions 223b and 224b may have, for example, a + shape by the cutout portions 261, 262, 263, and 264.

In an embodiment, the first to fourth cutout portions 261, 262, 263, and 264 may have shapes corresponding to shapes of the first to fourth auxiliary electrodes 251b, 252b, 253b, and 254b, respectively. For example, as illustrated in FIGS. 29A and 29B, the first to fourth cutout portions 261, 262, 263, and 264 may have a rectangular shape corresponding to shapes of the auxiliary electrodes 251b, 252b, 253b, and 254b. However, an embodiment thereof is not limited thereto, and the auxiliary electrodes 251b, 252b, 253b, and 254b may have various shapes such as an arc shape, and the first to fourth cutout portions 261, 262, 263, and 264 may have various shapes corresponding to the shapes of the auxiliary electrodes 251b, 252b, 253b, and 254b. A portion a of the auxiliary electrodes 251b, 252b, 253b, and 254b may be disposed in the cutout portions 261, 262, 263, and 264.

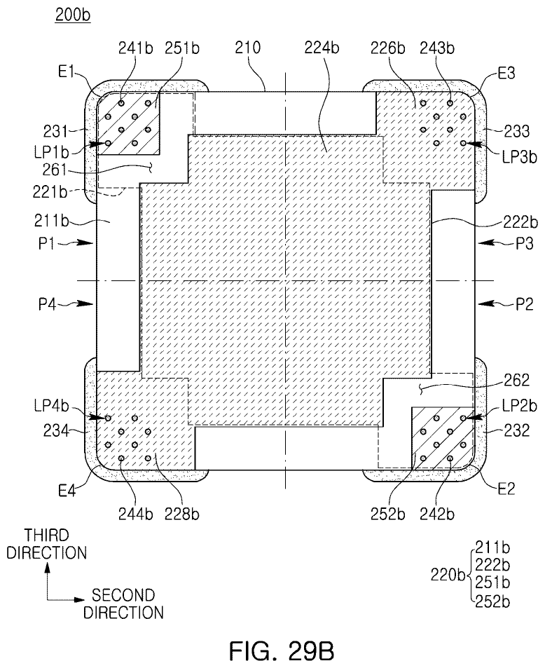

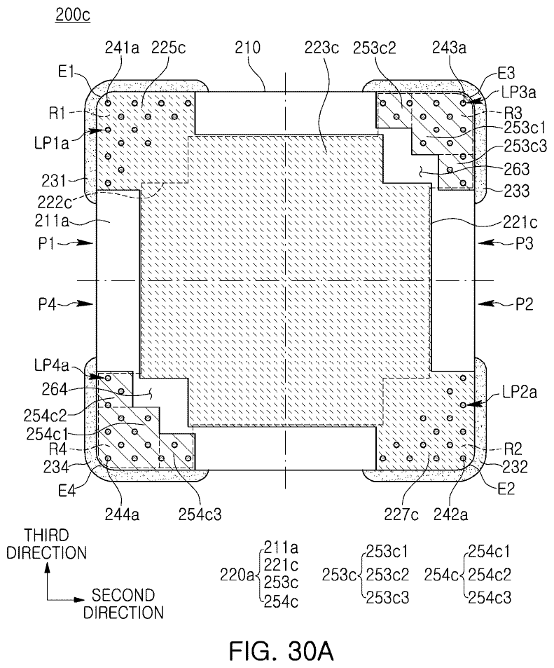

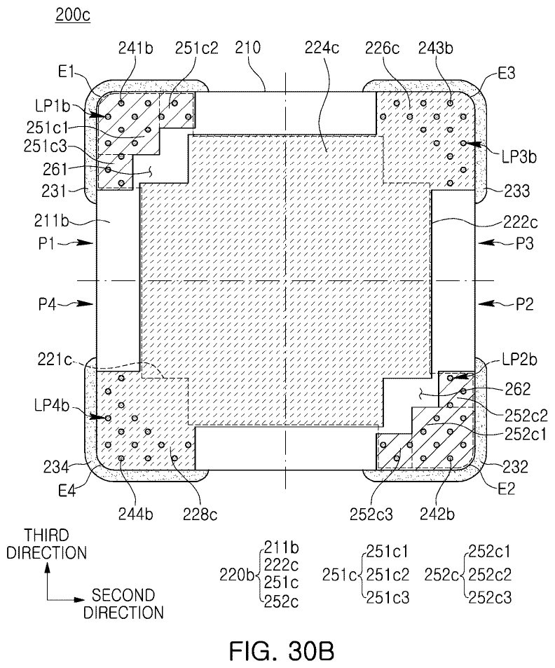

FIGS. 30A and 30B are cross-sectional diagrams illustrating a multilayer electronic component according to a second modified example of a second embodiment of the present disclosure, corresponding to FIGS. 27A and 27B.

Hereinafter, a multilayer electronic component 200c according to a second modified example of the second embodiment will be described with reference to FIGS. 30A and 30B. The same/similar reference numerals are used for the same/similar components of the multilayer electronic component 100d and 200a described in FIGS. 11A and 11B, and FIGS. 23 to 28, and overlapping descriptions will not be provided.

Referring to FIG. 30A, a first internal electrode 221c may include a first main portion 223c, a first lead portion 225c extending from the first main portion 223c and exposed to at least one of the third and fifth surfaces 3 and 5, and a second lead portion 227c extending from the first main portion 223c and exposed to at least one of the fourth and sixth surfaces 4 and 6.

Referring to FIG. 30B, the second internal electrode 222c may include a second main portion 224c, a third lead portion 226c extending from the second main portion 224c and exposed to at least one surface of the fourth and fifth surfaces 4 and 5, and a fourth lead portion 228c extending from the second main portion 224c and exposed to at least one surface of the third and sixth surfaces 3 and 6.

The auxiliary electrodes 251c, 252c, 253c, and 254c may be disposed in the first to fourth portions P1, P2, P3, and P4, respectively, and may be connected to the first to fourth external electrodes 231, 232, 233, and 234.

The first auxiliary electrode 251c may include a first connection portion 251c1 exposed to a portion of the third surface 3 and a portion of the fifth surface 5, a first extension portion 251c2 extending from the first connection portion 251c1 toward the third portion P3 and having a smaller dimension in the third direction than the first connection portion 251c1, and a second extension portion 251c3 extending from the first connection portion 251c1 toward the fourth portion P4 and having a smaller dimension in the second direction than the first connection portion 251c1.

The second auxiliary electrode 252c may include a second connection portion 252c1 exposed to a portion of the fourth surface 4 and a portion of the sixth surface 6, a third extension portion 252c2 extending from the second connection portion 252c1 toward the third portion P3 and having a smaller dimension in the second direction than the second connection portion 252c1, and a fourth extension portion 252c3 extending from the second connection portion 252c1 toward the fourth portion P4 and having a smaller dimension in the third direction than the second connection portion 252c1.

The third auxiliary electrode 253c may include a third connection portion 253c1 exposed to a portion of the fourth surface 4 and a portion of the fifth surface 5, a fifth extension portion 253c2 extending from the third connection portion 253c1 toward the first portion P1 and having a smaller dimension in the third direction than the third connection portion 253c1, and a sixth extension portion 253c3 extending from the third connection portion 253c1 toward the second portion P2 and having a smaller dimension in the second direction than the third connection portion 253c1.

The fourth auxiliary electrode 254c may include a fourth connection portion 254c1 exposed to a portion of the third surface 3 and a portion of the sixth surface 6, a seventh extension portion 254c2 extending from the fourth connection portion 254c1 toward the first portion P1 and having a smaller dimension in the second direction than the fourth connection portion 254c1, and an eighth extension portion 254c3 extending from the fourth connection portion 254c1 toward the second portion P2 and having a smaller dimension in the third direction than the fourth connection portion 254c1.

The multilayer electronic component 200c may effectively prevent the margin region from being recessed due to external stress by including the first to eighth extension portions 151d2, 151d3, 152d2, 152d3, 153d2, 153d3, 154d2, and 154d3.

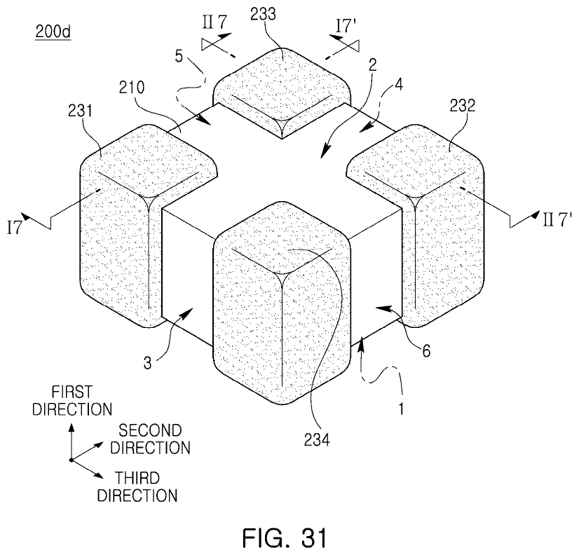

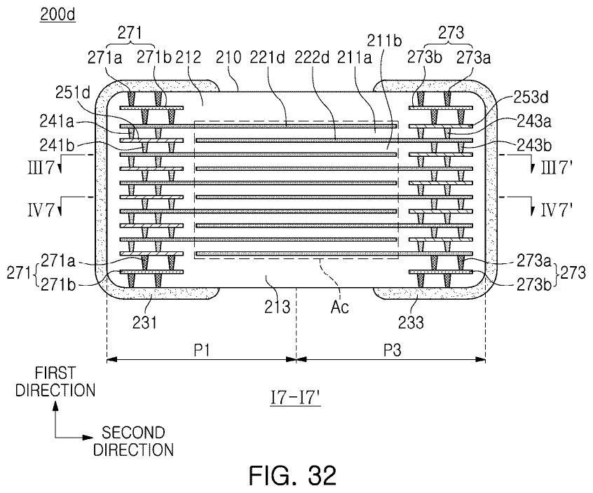

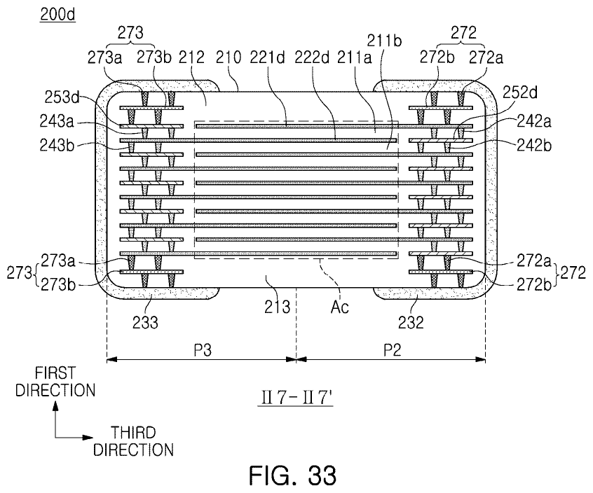

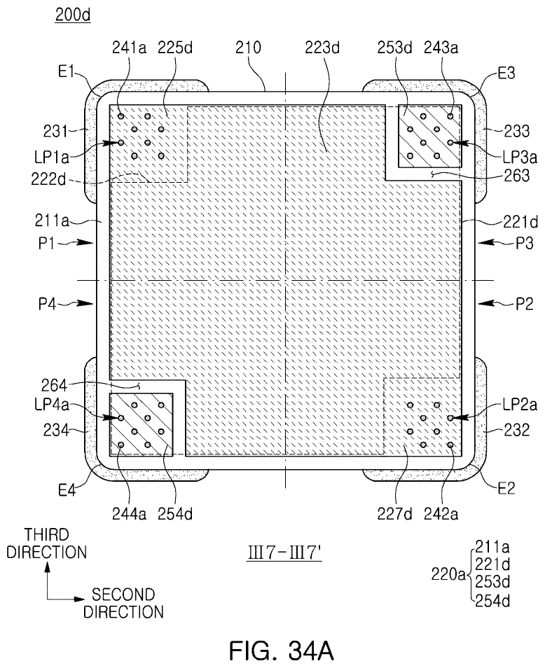

FIG. 31 is a perspective diagram illustrating a multilayer electronic component according to a third modified example of a second embodiment of the present disclosure. FIG. 32 is a cross-sectional diagram taken along line I7-I7′ in FIG. 31. FIG. 33 is a cross-sectional diagram taken along line II7-II7′ in FIG. 31. FIG. 34A is a cross-sectional diagram taken along line III7-III7′ in FIG. 32. FIG. 34B is a cross-sectional diagram taken along line IV7-IV7′ in FIG. 32.

Hereinafter, a multilayer electronic component 200d according to a third modified example of the second embodiment will be described with reference to FIGS. 31 and 34b. The same/similar reference numerals are used for the components of the multilayer electronic components 100f and 200a described in FIGS. 16 to 19B, and FIGS. 23 to 28, and overlapping descriptions will not be provided.

Referring to FIG. 34A, the first internal electrode 221d may include a first main portion 223d overlapping the second internal electrode 222d in the first direction, a first lead portion 225d disposed in the first portion P1, extending from the first main portion 223d and not overlapping the second internal electrode 222d, and a second lead portion 227d disposed in the second portion P2, extending from the first main portion 223d and not overlapping the second internal electrode 222d.

Referring to FIG. 34B, the second internal electrode 222d may include a second main portion 224d overlapping the first internal electrode 221d in the first direction, a third lead portion 226d disposed in the third portion P3, extending from the second main portion 224d and not overlapping the first internal electrode 221d, and a fourth lead portion 228d disposed in the fourth portion P4, extending from the second main portion 224d and not overlapping the first internal electrode 221d.

The second internal electrode 222d may include first and second cutout portions 261 and 262 disposed in the first and second portions P1 and P2, respectively, and the first internal electrode 221d may include third and fourth cutout portions 263 and 264 disposed in the third and fourth portions P3 and P4, respectively.

The first to fourth auxiliary electrodes 251d, 252d, 253d, and 254d may be disposed in the first to fourth cutout portions 161, 162, 163, and 164, respectively. The first to fourth auxiliary electrodes 251d, 252d, 253d, and 254d may be spaced apart from the first to fourth external electrodes 231, 232, 233, and 234. The first to fourth auxiliary electrodes 251d, 252d, 253d, and 254d may be disposed in the first to fourth cutout portions 261, 262, 263, and 264, respectively, but an embodiment thereof is not limited thereto, and a portion of the auxiliary electrodes 251d, 252d, 253d, and 254d may be disposed externally of the cutout portions 261, 262, 263, and 264.

The first to fourth auxiliary electrodes 251d, 252d, 253d, and 254d may have a shape corresponding to the shape of the first to fourth cutout portions 261, 262, 263, and 264, respectively, and may have, for example, a square shape, but an embodiment thereof is not limited thereto.

The multilayer electronic component 200d may include a first contact structure 271 disposed in the first portion P1, penetrating the cover portions 212 and 213, and connecting the first internal electrode 221d or the first auxiliary electrode 251d to the first external electrode 231 disposed in an outermost region with respect to the first direction.

The first contact structure 271 may include a first through-electrode 271a and a first dummy electrode 271b alternately disposed in the first direction. The first dummy electrode 271b may be connected to the first external electrode 231 on the third and fifth surfaces 3 and 5, but an embodiment thereof is not limited thereto. The first contact structure 271 may be disposed in the first and second cover portions 212 and 213, respectively.

The first contact structure 271 may be formed in a similar manner to the auxiliary electrode and via electrode. For example, the first contact structure 271 may be formed by forming a dummy electrode pattern on a sheet for forming a cover portion on which a via is formed, and laminating two or more layers of a sheet for forming a cover portion on which the dummy electrode pattern is formed.

The first contact structure 271 may have a structure similar to that of the auxiliary electrode and via electrode. For example, a plurality of the first through-electrode 271a may be disposed, and the plurality of first through-electrodes 271a may be arranged in the second and third directions. For example, the plurality of first through-electrodes 271a disposed on the same level may have a first or second grid pattern. Two first through-electrodes 271a adjacent to each other in the first direction may not overlap each other in the first direction.

Similarly, the multilayer electronic component 200d may include a second contact structure 272 disposed in the second portion P2, penetrating the cover portions 212 and 213, and connecting the first internal electrode 221d or the second auxiliary electrode 252d to the second external electrode 232 disposed in an outermost region with respect to the first direction. The second contact structure 272 may include a second through-electrode 272a and a first dummy electrode 272b alternately disposed in the first direction. The second contact structure 272 may be disposed in the first and second cover portions 212 and 213, respectively.

The multilayer electronic component 200d may include a third contact structure 273 disposed in the third portion P3, penetrating the cover portions 212 and 213, and connecting the second internal electrode 222d or the third auxiliary electrode 253d disposed in an outermost region with respect to the first direction to the third external electrode 233. The third contact structure 273 may include a third through-electrode 273a and a third dummy electrode 273b alternately disposed in the first direction. The third contact structure 273 may be disposed in the first and second cover portions 212 and 213, respectively.

The multilayer electronic component 200d may include a fourth contact structure (not illustrated) disposed in the fourth portion P4, penetrating the cover portions 212 and 213, and connecting the second internal electrode 222d or the fourth auxiliary electrode 254d disposed in an outermost region with respect to the first direction to the fourth external electrode 234. The fourth contact structure may include a fourth through-electrode and a fourth dummy electrode alternately disposed in the first direction. The fourth contact structure may be disposed in the first and second cover portions 212 and 213, respectively.

Hereinafter, a specific description of the second to fourth contact structure will not be provided. However, the second to fourth contact structure may be configured similarly to the first contact structure. Accordingly, the description of the first contact structure 271 may be applied to the second to fourth contact structure unless otherwise indicated.

To be in contact with the contact structure, the first to fourth external electrodes 231, 232, 233, and 234 may be disposed on the first surface and/or the second surface 1, 2, respectively. The first to fourth external electrodes 231, 232, 233, and 234 may be disposed on the upper surface and/or the lower surface of the body 210 and may extend to the side surface of the body 210.

Since electrical connection between the internal electrodes 221d, 222d and the external electrodes 231, 232, 233, and 234 may be assured through the contact structure, the first and second internal electrodes 221d and 222d may be spaced apart from the third to sixth surfaces 3, 4, 5, and 6. That is, the first to fourth lead portions 225d, 227d, 226d, and 228d may be spaced apart from an outer surface of the body 210. Accordingly, deterioration of moisture resistance reliability of the multilayer electronic component 200d may be prevented.

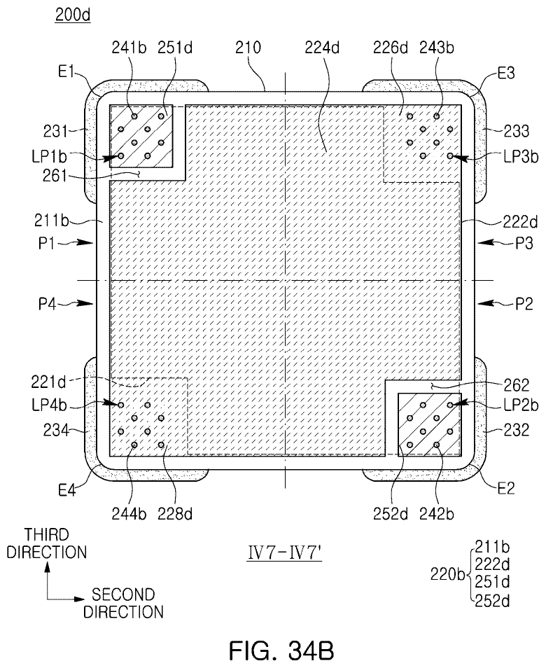

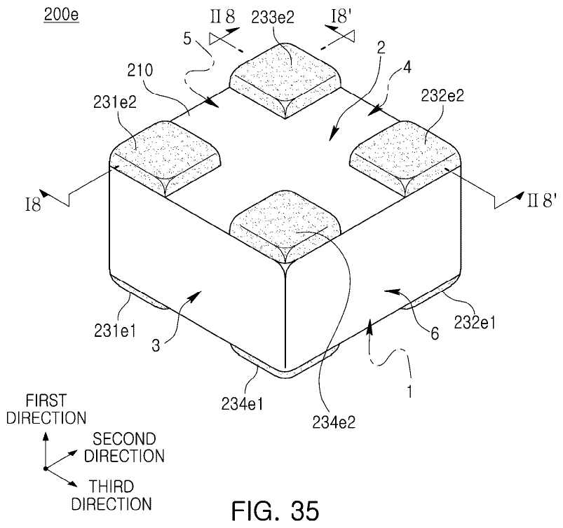

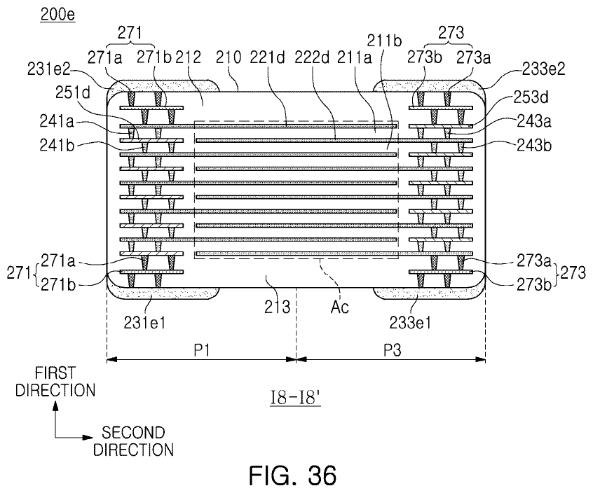

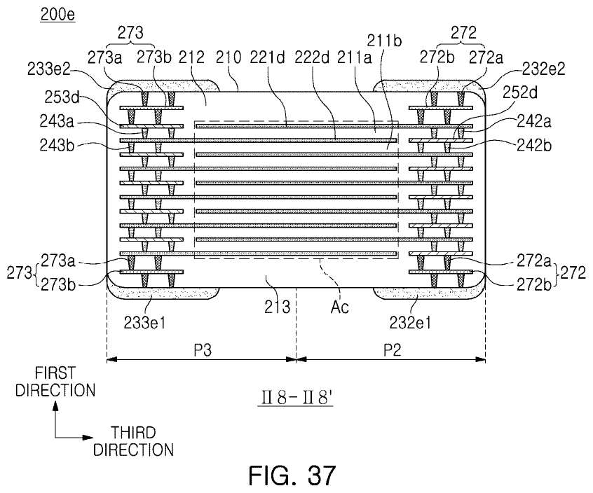

FIG. 35 is a perspective diagram illustrating a multilayer electronic component according to a fourth modified example of a second embodiment. FIG. 36 is a cross-sectional diagram taken along line I8-I8′ in FIG. 34. FIG. 37 is a cross-sectional diagram taken along line II8-II8′ in FIG. 34.

Hereinafter, a multilayer electronic component 200e according to a third modified example of the second embodiment will be described with reference to FIGS. 35 to 37. The same/similar reference numerals are used for the components of the multilayer electronic components 100g and 200d described in FIGS. 20 to 22, FIG. 31 and FIG. 34B, and the overlapping description will not be provided.

First external electrodes 231e1 and 231e2, second external electrodes 232e1 and 232e2, third external electrodes 233e1 and 233e2, and fourth external electrodes 234e1 and 234e2 may be disposed on the first and second surfaces 1 and 2, respectively. The first to fourth external electrodes 231e1, 232e1, 233e1, and 234e1 disposed on the first surface 1 and the first to fourth external electrodes 231e2, 232e2, 233e2, and 234e2 disposed on the second surface 2 may be spaced apart from each other. That is, the external electrode of the multilayer electronic component 200e may have a lower electrode form.

The first external electrodes 231e1 and 231e2, the second external electrodes 232e1 and 232e2, the third external electrodes 233e1 and 233e2, and the fourth external electrodes 234e1 and 234e2 may not extend from the third to sixth surfaces 3, 4, 5, and 6, respectively, but an embodiment thereof is not limited thereto, and the first external electrodes 231e1 and 231e2, the second external electrodes 232e1 and 232e2, the third external electrodes 233e1 and 233e2, and/or the fourth external electrodes 234e1 and 234e2 may extend from at least one surface of the third to sixth surfaces 3, 4, 5, and 6.

Since the multilayer electronic component 200e may assure an electrical connection between the internal electrode and the external electrode through the contact structures 271, 272, and 273, the first and second internal electrodes 221d and 222d may be spaced apart from the third surface to the sixth surface 3, 4, 5, and 6. Also, since the external electrode has a lower electrode form disposed on the first and second surfaces 1 and 2, capacitance and warpage strength per unit volume of the multilayer electronic component 200e may be improved.

In the drawing, a lower electrode form in which the external electrodes are disposed on the first and second surfaces 1 and 2, respectively, an embodiment thereof is not limited thereto, and the first to fourth external electrodes may be disposed on one surface of the first and second surfaces 1 and 2 and may not be disposed on the other surface. That is, the first to fourth external electrodes may be disposed on the first surface 1 and may not be disposed on the second surface 2, or may be disposed on the second surface 2 and may not be disposed on the first surface 1.

### (Method of Manufacturing Multilayer Electronic Component)

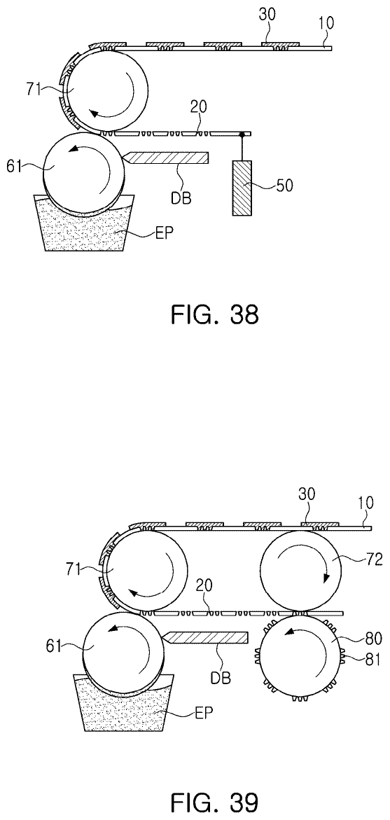

FIG. 38 is a cross-sectional diagram illustrating a filling and printing process for manufacturing a multilayer electronic component according to a first or second embodiment.

Hereinafter, with reference to FIG. 38, an example of a method for manufacturing a multilayer electronic component 100a and 200a according to the first embodiment or the second embodiment will be described.

A method of manufacturing a multilayer electronic component is described with respect to the multilayer electronic component 100a and 200a according to the first embodiment or the second embodiment, and the method may be applied to the multilayer electronic components 100b, 100c, 100d, 100e, 100f, and 100g according to the first to sixth modified examples of the first embodiment and the multilayer electronic components 200b, 200c, 200d, and 200e according to the first to fourth modified examples of the second embodiment unless otherwise indicated.

Hereinafter, each process of a method for manufacturing a multilayer electronic component will be described.

### (Process of Preparing Dielectric Sheet)

Dielectric powder to form a dielectric sheet 10 may be prepared. Examples of the dielectric powder may include BaTiO₃, (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1), Ba(Ti_{1-y}Zr_{y})O₃ (0<y<1), CaZrO₃, or (Ca₁₋ₓSrₓ)(Zr_{1-y}Ti_{y})O₃ (0<x≤0.5, 0<y≤0.5). The BaTiO₃ powder may be synthesized by reacting a titanium raw material such as titanium dioxide with a barium raw material such as barium carbonate, for example. The method of synthesizing the dielectric powder may include, for example, a solid-state method, a sol-gel method, a hydrothermal synthesis method, etc., but an embodiment thereof is not limited thereto.

Thereafter, the prepared dielectric powder may be dried and pulverized, and mixed with an organic solvent such as ethanol and a binder such as polyvinyl butyral may be mixed to manufacture a dielectric slurry, and the dielectric slurry may be applied to a carrier film and may be dried, thereby manufacturing a dielectric sheet 10.

The dielectric sheet 10 may form a dielectric layer by firing of the unit laminate described later.

### (Process of Forming Via)

The manufactured dielectric sheet 10 may be continuously supplied, for example, by moving from a supply roller (not illustrated) on which the dielectric sheet 10 is wound to a rewind roller (not illustrated) which rewinds the dielectric sheet 10.

In this case, a via 20 may be formed in the dielectric sheet 10 continuously supplied. The process of forming the via 20 may be performed, for example, by irradiating the dielectric sheet 10 with a laser. The laser may be irradiated from a laser device 50 disposed on the dielectric sheet 10.

The type of the laser device 50 is not limited to any particular example, and examples thereof a CO₂ laser, a YAG laser, a femtosecond laser, or a picosecond UV laser may be used. The via 20 may be formed by laser processing such that the via 20 have a tapered shape in which a width may gradually decrease from one surface of the dielectric sheet 10 to the other surface.

### (Filling Process)

Thereafter, a filling process for filling the via 20 with electrode paste EP may be performed. The electrode paste EP may include, for example, metal powder, a binder, an organic solvent, or the like.

The method for filling the via 20 with the electrode paste EP is not limited to any particular example. For example, as illustrated in FIG. 57, the dielectric sheet 10 may pass between the application roller 61 and the cylinder 71. The application roller 61 may be in contact with the electrode paste EP, and the electrode paste EP may be filled in the concave portion (not illustrated) formed on the outer surface of the application roller 61 by rotational driving of the application roller 61.

Meanwhile, the application roller 61 and the cylinder 71 may apply pressure to the dielectric sheet 10 by rotating in opposite directions. The electrode paste EP applied to the outer surface of the application roller 61 by pressure may be filled into the via 20 formed on the moving dielectric sheet 10. The electrode paste EP filled into the via 20 may form a via electrode by firing of the unit laminate described later.

The excess electrode paste EP applied to an external surface of the application roller 61 may be removed using a doctor blade (DB).

### (Printing Process)

A printing process for printing an internal electrode pattern 30 connected to the via 20 on the dielectric sheet 10 may be performed. The method for forming the internal electrode pattern 30 is not limited to any particular example. For example, the internal electrode pattern 30 may be formed using an application roller 61 and a cylinder 71. That is, the printing process may include a process for supplying electrode paste EP to an outer surface of the application roller 61, and a process for applying electrode paste EP on the dielectric sheet 10 by allowing the dielectric sheet 10 to be in contact with the application roller 61.

In this case, by controlling the shape of the concave portion (not illustrated) formed on the external surface of the application roller 61, the via 20 may be filled with electrode paste EP and simultaneously the internal electrode pattern 30 may be formed. That is, in an embodiment, the filling process and the printing process may be performed simultaneously. The printed internal electrode pattern 30 may be dried using a drying device.

The internal electrode pattern 30 may form the internal electrode by firing the unit laminate described later. Also, although not illustrated, the auxiliary electrode pattern forming the auxiliary electrode by firing the unit laminate may also be formed in the same manner as the internal electrode pattern 30.

### (Laminating Process)

To form the multilayer electronic component 100a according to the first embodiment, a predetermined number of dielectric sheets 10 on which different internal electrode patterns 30 are printed may be laminated and a laminate may be formed. To form connection electrodes 141, 142, 143, and 144, the vias 20 formed on different dielectric sheets 10 may be aligned in the laminate process. However, the vias 20 formed on each dielectric sheet 10 may not be perfectly aligned with each other, and accordingly, the laminated vias 20 may be laminated with center axes thereof shifted from each other. Meanwhile, since the vias 20 may have a tapered shape, vias formed on different dielectric sheets 10 may be easily aligned.

To form a multilayer electronic component 200a according to the second embodiment, a predetermined number of dielectric sheets 10 on which different internal electrode patterns 30 are printed may be laminated and a laminate may be formed. Also, the auxiliary electrode pattern 40 may be appropriately formed on the dielectric sheet 10.

As for the laminate for forming the multilayer electronic component 200a according to the second embodiment, the auxiliary electrode pattern 40 may be included, such that it may not be necessary to align the vias 20 formed on different dielectric sheets 10, such that process convenience may be assured.

In the upper and lower portions in the first direction of the laminate, a sheet for forming the cover portion in which the internal electrode pattern and the auxiliary electrode pattern are not formed may be laminated in a predetermined number of layers to form the cover portion after firing.

To form the multilayer electronic component 100e, 100f, and 100g according to the fourth to sixth modified examples of the first embodiment, a sheet for forming the cover portion in which the vias are formed may be laminated in a predetermined number of layers in the upper and lower portions in the first direction of the laminate.

To manufacture the multilayer electronic component 200c, 200d, and 200e according to the second to fourth modified example of the second embodiment, a sheet for forming a cover portion in which a via and a dummy electrode pattern are formed may be laminated in a predetermined number of layers on the upper and lower portions of the laminate in the first direction.

### (Cutting and Firing Process)

Thereafter, the laminate may be pressed, and the laminate may be cut along a plurality of cutting lines CL1 and CL2, thereby obtaining a unit laminate. Also, the unit laminate may be fired to obtain a body. The firing may be performed at a temperature of, for example, 1000° C. or higher and 1400° C. or lower, but an embodiment thereof is not limited thereto.

### (Process of Forming External Electrode)

Thereafter, an external electrode may be formed on the body. The method of forming the external electrode is not limited to any particular example.

When the external electrode includes a firing electrode layer, the process of forming an external electrode may include a process of dipping the body into a firing paste including a metal powder and glass frit, a binder, and an organic solvent, and firing the firing paste at a temperature of 500°° C. to 900° C.

However, an embodiment thereof is not limited thereto, and to manufacture the multilayer electronic components 100g and 200e according to the fifth and sixth modified examples of the first embodiment and the third and fourth modified examples of the second embodiment having an electrode structure, the process of forming an external electrode may include a process of transferring a sheet including a metal to a body.

When the external electrode includes a conductive resin layer, the process of forming an external electrode may include a process of dipping the body into a conductive resin composition including a metal powder, resin, a binder, and an organic solvent, and performing a curing heat treatment at a temperature of 250° C. to 550° C. When the external electrode includes a thin-film electrode layer, the process of forming an external electrode may include a process of performing an atomic layer deposition (ALD) method, a chemical vapor deposition (CVD) method, and/or a sputtering method.

Also, electrolytic plating and/or electroless plating may be further performed, thereby forming a plating layer.

FIGS. 39 to 41 are cross-sectional diagrams illustrating a modified example of FIG. 38.

Hereinafter, a modified example of a method of manufacturing a multilayer electronic component according to the first embodiment or the second embodiment will be described with reference to FIGS. 39 to 41.

The same/similar reference numerals are used for the same/similar components described in FIG. 38, and overlapping descriptions will not be provided.

Referring to FIG. 58, a process of forming a via 20 may be performed by allowing a dielectric sheet 10 to be in contact with an imprint roller 80 having a convex portion 81 disposed on an outer surface thereof.

Specifically, the dielectric sheet 10 may pass between the imprint roller 80 and the cylinder 72. In this case, the imprint roller 80 and the cylinder 72 may apply pressure to the dielectric sheet 10 by rotating in opposite directions. The via 20 may be formed on the dielectric sheet 10 by the pressure and the convex portion 81.

The convex portion 81 formed on the outer surface of the imprint roller 80 may have a pattern corresponding to the lattice pattern of the via electrode.

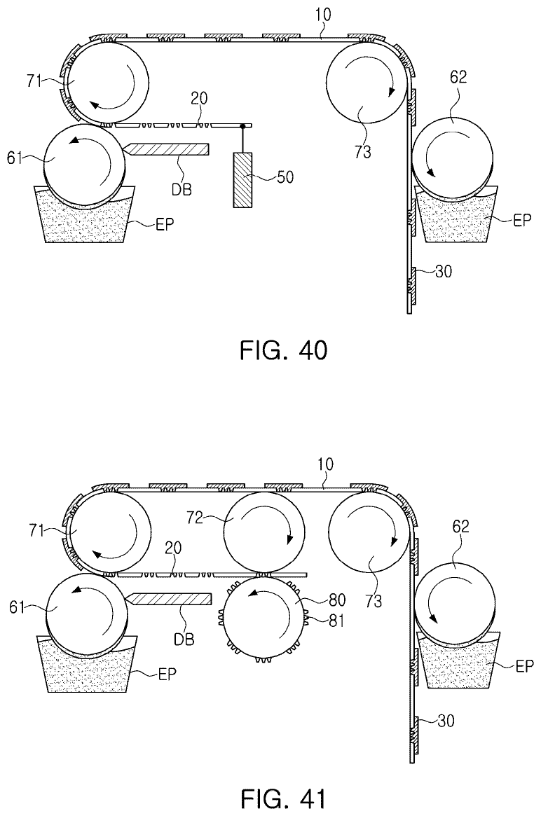

Referring to FIG. 40, after the via 20 is formed by irradiating the dielectric sheet 10 with a laser, the electrode paste EP may be filled into the via 20 using the application roller 61 and the cylinder 71.

Thereafter, the electrode paste EP may be applied on the dielectric sheet 10 using the application roller 62 and the cylinder 73 and the internal electrode pattern 30 may be separately formed. That is, the filling process and the printing process may be performed in order.

Referring to FIG. 41, a via 20 may be formed on an outer surface of a dielectric sheet 10 using the imprint roller 80 and the cylinder 72 having a convex portion 81 disposed thereon, electrode paste EP may be filled into the via 20 using the application roller 61 and the cylinder 71.

Specifically, the dielectric sheet 10 may pass between the imprint roller 80 and the cylinder 72. In this case, the imprint roller 80 and the cylinder 72 may apply pressure to the dielectric sheet 10 by rotating in opposite directions, and accordingly, the via 20 may be formed in the dielectric sheet 10.

Thereafter, the electrode paste EP may be applied to the dielectric sheet 10 using the application roller 62 and the cylinder 73 and an internal electrode pattern 30 may be separately formed. That is, the filling process and the printing process may be performed in order.

According to the aforementioned embodiments, a multilayer electronic component having excellent mechanical strength and electrical properties may be provided.

The embodiments do not necessarily limit the scope of the embodiments to a specific embodiment form. Instead, modifications, equivalents and replacements included in the disclosed concept and technical scope of this description may be employed. Throughout the specification, similar reference numerals are used for similar elements.

In the embodiments, the term “embodiment” may not refer to one same embodiment, and may be provided to describe and emphasize different unique features of each embodiment. The suggested embodiments may be implemented do not exclude the possibilities of combination with features of other embodiments. For example, even though the features described in an embodiment are not described in the other embodiment, the description may be understood as relevant to the other embodiment unless otherwise indicated.

The terms “first,” “second,” and the like may be used to distinguish one element from the other, and may not limit a sequence and/or an importance, or others, in relation to the elements. In some cases, a first element may be referred to as a second element, and similarly, a second element may be referred to as a first element without departing from the scope of right of the example embodiments.

While the embodiments have been illustrated and described above, it will be configured as apparent to those skilled in the art that modifications and variations could be made without departing from the scope of the present disclosure as defined by the appended claims.

What is claimed is:

1. A multilayer electronic component, comprising:
a body including a dielectric layer and first and second internal electrodes alternately disposed with the dielectric layer, and including first and second surfaces opposing each other in a first direction, a third surface and a fourth surface connected to the first and second surfaces and opposing each other in a second direction, and fifth and sixth surfaces connected to the first to fourth surfaces and opposing each other in a third direction, the body including first to fourth portions;
first and second external electrodes disposed on the first and second portions, respectively, and connected to the first internal electrodes;
third and fourth external electrodes disposed on the third and fourth portions, respectively, and connected to the second internal electrodes; and
a connection electrode disposed in at least one of the first to fourth portions, penetrating the dielectric layer, connecting two first internal electrodes adjacent to each other in the first direction, or connecting two second internal electrodes adjacent to each other in the first direction,
wherein the first portion and the third portion are connected to each other in the second direction, the first portion and the fourth portion are connected to each other in the third direction, the second portion and the third portion are connected to each other in the third direction, and the second portion and the fourth portion are connected to each other in the second direction,
wherein the first portion includes a corner at which the third and fifth surfaces meet each other, the second portion includes a corner at which the fourth and sixth surfaces meet each other, the third portion includes a corner at which the fourth and fifth surfaces meet each other, and the fourth portion includes a corner at which the third and sixth surfaces meet each other, and
wherein, the connection electrode has a plurality of via electrodes laminated in the first direction, and via electrodes adjacent to each other in the first direction among the plurality of via electrodes, are shifted from each other in a direction perpendicular to the first direction.

2. The multilayer electronic component of claim 1, wherein a plurality of the connection electrodes penetrating the same dielectric layer are disposed.

3. The multilayer electronic component of claim 2, wherein the plurality of the connection electrodes penetrating the same dielectric layer are arranged in the second and third directions.

4. The multilayer electronic component of claim 1,
wherein the first internal electrode includes a first main portion overlapping the second internal electrode in the first direction, a first lead portion extending from the first main portion, not overlapping the second internal electrode in the first direction and extending to at least one surface among the third and fifth surfaces, and a second lead portion extending from the first main portion, not overlapping the second internal electrode in the first direction and extending to at least one surface among the fourth and sixth surfaces, and
wherein the second internal electrode includes a second main portion overlapping the first internal electrode in the first direction, a third lead portion extending from the second main portion, not overlapping the first internal electrode in the first direction and extending to at least one surface among the fourth and fifth surfaces, and a fourth lead portion extending from the second main portion, not overlapping the first internal electrode in the first direction and extending to at least one surface among the third and sixth surfaces.

5. The multilayer electronic component of claim 1, further comprising:
an auxiliary electrode disposed in at least one of the first to fourth portions, and disposed between via electrodes adjacent to each other in the first direction among the plurality of via electrodes.

6. The multilayer electronic component of claim 1,
wherein the second internal electrode includes first and second cutout portions disposed in the first and second portions, respectively, and
wherein the first internal electrode includes third and fourth cutout portions disposed in the third and fourth portions, respectively.

7. The multilayer electronic component of claim 6, further comprising:
an auxiliary electrode disposed in at least one of the first to fourth portions and disposed between via electrodes adjacent to each other in the first direction among the plurality of via electrodes,
wherein each of the first to fourth cutout portion has a shape corresponding to a shape of the auxiliary electrode.

8. The multilayer electronic component of claim 6, further comprising:
a first auxiliary electrode disposed in the first portion and disposed between via electrodes adjacent to each other in the first direction among the plurality of via electrodes,
wherein the first auxiliary electrode includes a first connection portion extending to a portion of the third surface and a portion of the fifth surface, a first extension portion extending from the first connection portion toward the third portion and having a smaller dimension in the third direction than the first connection portion, and a second extension portion extending from the first connection portion toward the fourth portion and having a smaller dimension in the second direction than the first connection portion.

9. The multilayer electronic component of claim 1,
wherein the first and second internal electrodes are spaced apart from the third surface to the sixth surface,
wherein the second internal electrode includes first and second cutout portions disposed in the first and second portions, respectively,
wherein the first internal electrode includes third and fourth cutout portions disposed in the third and fourth portions, respectively, and
wherein the multilayer electronic component further includes an auxiliary electrode disposed in at least one of the first to fourth cutout portions and disposed between via electrodes adjacent to each other in the first direction among the plurality of via electrodes.

10. The multilayer electronic component of claim 1,
wherein the two connection electrodes adjacent to each other in the first direction are shifted from each other in the direction perpendicular to the first direction.

11. The multilayer electronic component of claim 1,
wherein the body includes a capacitance formation portion in which the first and second internal electrodes are alternately disposed in the first direction with the dielectric layer interposed therebetween, and a cover portion disposed on both surfaces of the capacitance formation portion in the first direction, and
wherein the multilayer electronic component further includes a contact electrode disposed at least in one of the first to fourth portions, penetrating the cover portion, connecting the first internal electrode disposed in an outermost region with respect to the first direction to the first or second external electrode, or connecting the second internal electrode disposed in an outermost region with respect to the first direction to the third or fourth external electrode.

12. The multilayer electronic component of claim 11,
wherein the contact electrode includes a plurality of through-electrodes laminated in the first direction, and
wherein two through-electrodes adjacent to each other among the plurality of through-electrodes are shifted from each other in the direction perpendicular to the first direction.

13. The multilayer electronic component of claim 11,
wherein the first to fourth external electrodes are disposed on the first and second surfaces, respectively, and
wherein the first to fourth external electrodes disposed on the first surface are spaced apart from the first to fourth external electrodes disposed on the second surface.

14. The multilayer electronic component of claim 11, wherein the first to fourth external electrodes are disposed on one of the first and second surfaces, and not disposed on the other surface.

15. The multilayer electronic component of claim 1, wherein dimensions of the multilayer electronic component in the first to third directions are defined as T, L, and W, respectively, and each of T/L and T/W satisfies 0.6 or less.

16. The multilayer electronic component according to claim 15, wherein T, L, and W refer to maximum dimensions of the multilayer electronic component in the first to third directions, respectively.

17. A multilayer electronic component, comprising:
a body including first and second surfaces opposing each other in a first direction, a third surface and a fourth surface connected to the first and second surfaces and opposing each other in a second direction, and fifth and sixth surfaces connected to the first to fourth surfaces and opposing each other in a third direction, the body including first to fourth portions,
the body including a first internal electrode layer including a first dielectric layer, a first internal electrode disposed on the first dielectric layer, and third and fourth auxiliary electrodes disposed on the first dielectric layer, spaced apart from the first internal electrode and disposed on the third and fourth portion, respectively,
the body including a second internal electrode layer including a second dielectric layer, a second internal electrode disposed on the second dielectric layer, and first and second auxiliary electrodes disposed on the second dielectric layer, spaced apart from the second internal electrode, and disposed in the first and second portions, respectively, in the body, the first and second internal electrode layers are alternately disposed in the first direction;
first and second external electrodes disposed on the first and second portions, respectively, and connected to the first internal electrode;
third and fourth external electrodes disposed on the third and fourth portions, respectively, and connected to the second internal electrode;
a first via electrode disposed on the first portion, penetrating the first dielectric layer and connecting the first internal electrode to the first auxiliary electrode; and
a second via electrode disposed on the first portion, penetrating the second dielectric layer and connecting the first internal electrode to the first auxiliary electrode,
wherein the first portion and the third portion are connected to each other in the second direction, the first portion and the fourth portion are connected to each other in the third direction, the second portion and the third portion are connected to each other in the third direction, and the second portion and the fourth portion are connected to each other in the second direction,
wherein the first portion includes a corner at which the third and fifth surfaces meet each other, the second portion includes a corner at which the fourth and sixth surfaces meet each other, the third portion includes a corner at which the fourth and fifth surfaces meet each other, and the fourth portion includes a corner at which the third and sixth surfaces meet each other, and
wherein the first via electrode and the second via electrode are shifted from each other in a direction perpendicular to the first direction.

18. The multilayer electronic component of claim 17, wherein the first and second via electrodes do not overlap each other in the first direction.

19. The multilayer electronic component of claim 17,
wherein a plurality of the first via electrodes penetrating the same first dielectric layer are disposed, and a plurality of the second via electrodes penetrating the same second dielectric layer are disposed, and
wherein the first via electrodes penetrating the same first dielectric layer are arranged in the second and third directions, and the second via electrodes penetrating the same second dielectric layer are arranged in the second and third directions.

20. The multilayer electronic component of claim 19,
wherein the first dielectric layer includes a first region disposed between two first via electrodes adjacent to each other in the second or third direction among a plurality of the first via electrodes, and
wherein the plurality of the second via electrode overlaps the first region in the first direction.

21. The multilayer electronic component of claim 17,
wherein the first internal electrode includes a first main portion overlapping the second internal electrode in the first direction, a first lead portion extending from the first main portion, not overlapping the second internal electrode in the first direction, and extending to at least one surface among the third and fifth surfaces, and a second lead portion extending from the first main portion, not overlapping the second internal electrode in the first direction, and extending to at least one of the fourth and sixth surfaces,
wherein the second internal electrode includes a second main portion overlapping the first internal electrode in the first direction, a third lead portion extending from the second main portion, not overlapping the first internal electrode in the first direction and extending to at least one surface among the fourth and fifth surfaces, and a fourth lead portion extending from the second main portion, not overlapping the first internal electrode in the first direction, and extending to at least one of the third and sixth surfaces.

22. The multilayer electronic component of claim 17,
wherein the second internal electrode includes first and second cutout portions disposed in the first and second portions, respectively, and
wherein the first internal electrode includes third and fourth cutout portions disposed in the third and fourth portions, respectively.

23. The multilayer electronic component of claim 22, wherein the first to fourth cutout portions have shapes corresponding to shapes of the first to fourth auxiliary electrodes, respectively.

24. The multilayer electronic component of claim 22, wherein the first auxiliary electrode includes a first connection portion extending to a portion of the third surface and a portion of the fifth surface, a first extension portion extending from the first connection portion toward the third portion and having a smaller dimension in the third direction than the first connection portion, and a second extension portion extending from the first connection portion toward the fourth portion and having a smaller dimension in the second direction than the first connection portion.

25. The multilayer electronic component of claim 17,
wherein the first and second internal electrodes are spaced apart from the third surface to sixth surface,
wherein the second internal electrode includes first and second cutout portions disposed in the first and second portions, respectively,
wherein the first internal electrode includes third and second cutout portions disposed in the third and second portions, respectively, and
wherein the first to fourth auxiliary electrodes are disposed in the first to fourth cutout portion, respectively.

26. The multilayer electronic component of claim 17,
wherein the body includes a capacitance formation portion in which the first and second internal electrodes are alternately disposed in the first direction with the first or second dielectric layer interposed therebetween, and cover portions disposed on both surfaces of the capacitance formation portion opposing each other in the first direction, and
wherein the multilayer electronic component further includes a first contact structure disposed in the first portion, penetrating the cover portion, and connecting the first internal electrode disposed an outermost region with respect to the first direction or the first auxiliary electrode to the first external electrode.

27. The multilayer electronic component of claim 26,
wherein the first to fourth external electrodes are disposed on the first and second surfaces, respectively, and
wherein the first to fourth external electrodes disposed on the first surface are spaced apart from the first to fourth external electrodes disposed on the second surface.

28. The multilayer electronic component of claim 26, wherein the first to fourth external electrodes are disposed on one of the first and second surfaces and not disposed on the other surface.

29. The multilayer electronic component of claim 17, wherein dimensions of the multilayer electronic component in the first to third directions are defined as T, L, and W, respectively, and each of T/L and T/W satisfies 0.6 or less.

30. The multilayer electronic component according to claim 29, wherein T, L, and W refer to maximum dimensions of the multilayer electronic component in the first to third directions, respectively.

31. The multilayer electronic component of claim 17, further comprising:
a third via electrode disposed in the second portion, penetrating the first dielectric layer and connecting the first internal electrode to the second auxiliary electrode;
a fourth via electrode disposed in the second portion, penetrating the second dielectric layer and connecting the first internal electrode to the second auxiliary electrode;
a fifth via electrode disposed in the third portion, penetrating the first dielectric layer and connecting the second internal electrode to the third auxiliary electrode;
a sixth via electrode disposed in the third portion, penetrating the second dielectric layer and connecting the second internal electrode to the third auxiliary electrode;
a seventh via electrode disposed in the fourth portion, penetrating the first dielectric layer and connecting the second internal electrode to the fourth auxiliary electrode; and
an eighth via electrode disposed in the fourth portion, penetrating the second dielectric layer and connecting the second internal electrode to the fourth auxiliary electrode,
wherein the third via electrode and the fourth via electrode are shifted from each other in the direction perpendicular to the first direction,
wherein the fifth via electrode and the sixth via electrode are shifted from each other in the direction perpendicular to the first direction, and
wherein the seventh via electrode and the eighth via electrode are shifted from each other in the direction perpendicular to the first direction.
